(19) United States
(12) Patent Application Publication
(10) Pub. No.: US 2025/0108625 A1
(43) Pub. Date: Apr. 3, 2025

(54) PRINTING APPARATUS, CONTROL METHOD, AND STORAGE MEDIUM

(71) Applicant: CANON KABUSHIKI KAISHA, Tokyo (JP)

(72) Inventor: JUN YASUTANI, Kanagawa (JP)

(21) Appl. No.: 18/888,676

(22) Filed: Sep. 18, 2024

(30) Foreign Application Priority Data
Sep. 28, 2023 (JP) 2023-168502

(51) Int. Cl. B41J 2/18; B41J 2/045; B41J 2/175; B41J 2/195

(52) U.S. Cl. CPC B41J 2/18; B41J 2/04551; B41J 2/0458; B41J 2/17566; B41J 2/195

(57) ABSTRACT

A printing apparatus including a print unit to perform printing by ejecting ink by driving a heating element and a circulation path to circulate the ink to supply the print unit with the ink and resupply the print unit with the ink from the print unit includes a control unit to perform a first control of causing kogation adhesion to a protective layer covering the heating element by ejecting the ink through the nozzle, and a second control of making ink concentration adjustment in the circulation path by ejecting the ink from the nozzle for ink discharge from the circulation path and supplying the circulation path with an amount of the ink corresponding to the ink discharge amount. In consecutive execution of the first and second controls, the control unit uses the ink discharge in one of the controls for the ink discharge in the other control.

### BACKGROUND OF THE INVENTION

### Field of the Invention

The present invention relates to a printing apparatus, a control method, and a storage medium.

### Description of the Related Art

In a printing apparatus configured to eject ink using an inkjet method, for example, the ink is ejected from nozzles using thermal energy generated by heating elements. In such a printing apparatus, as a result of heating the ink with the heating elements, kogation generated from the ink adheres to the surfaces of the heating elements and changes the ejection characteristics. Japanese Patent Laid-Open No. 2015-214141 discloses a technique for removing kogation generated.

Meanwhile, in a case where the ink is ejected from a state where there is almost no kogation, kogation is remarkably generated on the surfaces of the heating elements. For this reason, until the kogation adhesion is stabilized, the ejection characteristics significantly change and are unstable. Japanese Patent Laid-Open No. 2014-131867 discloses a technique related to aging for turning a state where no kogation is present on the surfaces of the heating elements to a state where an adequate degree of kogation adheres to the surfaces.

Further, a print head configured to eject ink is provided with a sub-heater to make the temperature uniform. In order to suppress thickening of the ink due to the heating by the sub-heater, the printing apparatus also includes a circulation path configured to supply the ink to the print head and collect the ink from the print head and causes the ink to circulate in the circulation path. In the printing apparatus including the circulation path, since the fresh ink is always supplied to the nozzles for ink ejection, evaporation of a liquid component in the ink from the nozzles is promoted, so that the concentration of the circulating ink is increased. Japanese Patent Laid-Open No. 2018-008513 discloses a technique for adjusting the ink concentration increased in the circulation path.

However, the techniques disclosed in Japanese Patent Laid-Open Nos. 2015-214141 and 2014-131867 are techniques specialized only for kogation control, while the technique disclosed in Japanese Patent Laid-Open No. 2018-008513 is a technique specialized only for ink concentration adjustment. For this reason, in a case where a printing apparatus is configured to simply implement the techniques disclosed in Japanese Patent Laid-Open Nos. 2015-214141 and 2014-131867 and the technique disclosed in Japanese Patent Laid-Open No. 2018-008513, there are new concerns such as a decrease in the productivity due to an increase in the downtime and an increase in the amount of waste ink.

### SUMMARY OF THE INVENTION

The present invention was made in view of the foregoing problems, and provides a technique capable of executing kogation control and concentration adjustment while reducing a decrease in productivity and an increase in the amount of waste ink.

A printing apparatus includes: a print unit configured to perform printing by ejecting an ink from a nozzle by using thermal energy generated by a heating element; a circulation path configured to circulate the ink so as to supply the print unit with the ink and resupply the print unit with the ink which flows out from the print unit; and a control unit configured to be capable of performing a first control of causing kogation to adhere to a protective layer covering the heating element by ejecting and discharging the ink through the nozzle, and a second control of making concentration adjustment of the ink in the circulation path by ejecting and discharging the ink from the nozzle to discharge the ink from the circulation path and supplying the circulation path with an amount of the ink corresponding to the amount of the ink thus discharged, wherein in a case where the first control and the second control are consecutively executed, the control unit uses the ink discharge in one of the controls for the ink discharge in the other control.

According to the present invention, it is possible to execute kogation control and ink concentration adjustment while reducing a decrease in productivity and an increase in the amount of waste ink.

Further features of the present invention will become apparent from the following description of exemplary embodiments with reference to the attached drawings.

### BRIEF DESCRIPTION OF THE DRAWINGS

FIG. 1 is a schematic structural diagram of a printing apparatus;

FIG. 2 is a block diagram illustrating a configuration of a control system of the printing apparatus;

FIG. 3 is a flowchart presenting detailed processes in image processing;

FIG. 4 is a schematic structural view of a circulation path;

FIGS. 5A and 5B are perspective structural views of a print head;

FIG. 6 is an exploded structural view of the print head;

FIGS. 7A and 7B are schematic structural views of an ejection module;

FIGS. 8A to 8F are schematic structural views of members constituting a channel member;

FIGS. 9A and 9B are views illustrating channels formed in the channel member;

FIGS. 10A and 10B are external appearance views of a print element board;

FIGS. 11A and 11B are views illustrating channels formed in the print element board;

FIG. 12 is a view illustrating a positional relationship between adjacent print elements;

FIGS. 13A and 13B are views illustrating a structure around a print element in a print element board;

FIGS. 14A to 14D are diagrams illustrating electric fields generated in a pressure chamber and negatively charged particles in the pressure chamber;

FIG. 15 is a graph presenting a relationship between an ejection shot count and an ejection speed in executing kogation control;

FIG. 16 is a timing chart of multiple processes executed in printing in the printing apparatus;

FIG. 17 is a block diagram illustrating a functional configuration of an engine controller;

FIG. 18 is a flowchart presenting detailed processes in obtaining processing;

FIG. 19 is a flowchart presenting detailed processes in a determination processing;

FIG. 20 is a flowchart presenting detailed processes in update processing, which is a subroutine of the determination processing in FIG. 19;

FIG. 21 is a diagram showing a relation between FIGS. 21A and 21B;

FIGS. 21A and 21B are flowcharts presenting detailed processes in determination processing in another embodiment; and

FIG. 22 is a flowchart presenting detailed processes in second update processing, which is a subroutine of the determination processing in FIG. 21B.

### DESCRIPTION OF THE EMBODIMENTS

Hereinafter, examples of embodiments of a printing apparatus, a control method, and a storage medium will be described in reference to the attached drawings. The following embodiments are not intended to limit the present invention. In addition, all the combinations of features described in the embodiments are not necessarily essential for the solution of the present invention. The positions and shapes of constituents described in the embodiments are just examples and are not intended to limit the present invention to only these.

### First Embodiment

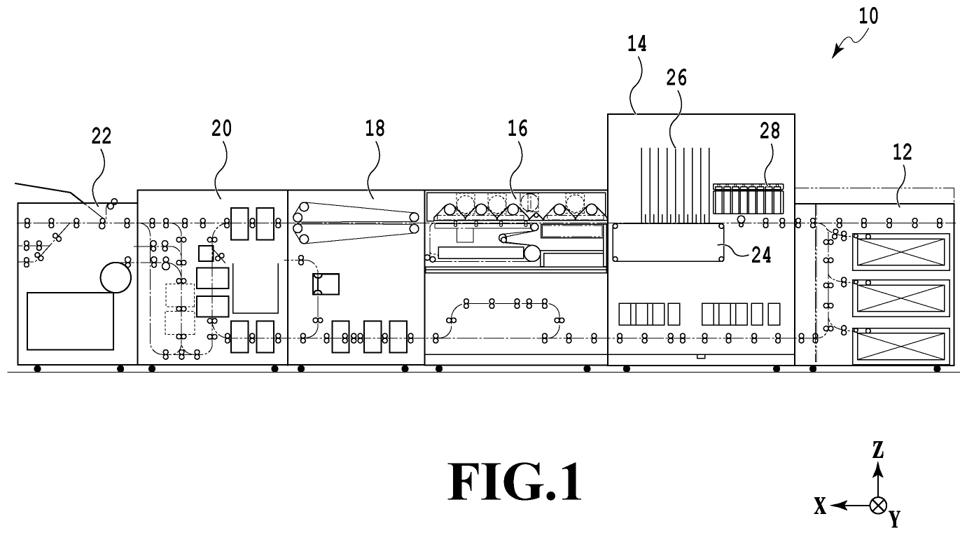

First, a printing apparatus according to a first embodiment will be described in reference to FIGS. 1 to 20.

### <Structure of Printing Apparatus>

FIG. 1 is a schematic structural diagram of a printing apparatus. A printing apparatus 10 in FIG. 1 includes a feed module 12 configured to feed a print medium in the form of a cut sheet and a print module 14 configured to print the print medium fed by the feed module 12. In addition, the printing apparatus 10 includes a first fixation module 16 configured to promote fixation of print agents onto a print medium by non-contact heating and a second fixation module 18 configured to promote fixation of the print agents onto the print medium by contact heating. Further, the printing apparatus 10 includes a cooling-reversing module 20 configured to cool a print medium and reverse a print medium for double-sided printing and a stacking module 22 to which printed products are delivered and which is configured to stack the delivered printed products. Furthermore, the printing apparatus 10 includes a control section 200 (to be described later) configured to control operations of the entire printing apparatus 10.

The print module 14 includes a conveyance belt 24 configured to convey a print medium fed from the feed module 12. The conveyance belt 24 conveys a print medium while fixing the print medium by air sucking. The print module 14 also includes print heads 26 arranged at a position opposed to the conveyance belt 24 and configured to perform printing by ejecting print agents onto a print medium being conveyed by the conveyance belt 24. Multiple print heads 26 are arranged side by side along a print medium conveyance direction. In the present embodiment, the printing apparatus 10 uses, as the print agents, not only four colors of pigment inks including a yellow (Y) ink, a magenta (M) ink, a cyan (C) ink, and a black (K) ink, but also a treatment liquid (P) for making a predetermined treatment on the inks ejected on the print medium. Therefore, in the present embodiment, the printing apparatus 10 includes, as the print heads 26, multiple line-type print heads not only for the four colors of inks including the Y ink, the M ink, the C ink, and the K ink, but also for the treatment liquid. Regarding the print heads 26 in the print module 14, the number of colors is not limited to four and the number of print heads is not limited to five as described above. The inks are not limited to inks containing pigments and various known inks such as inks containing dyes may be used.

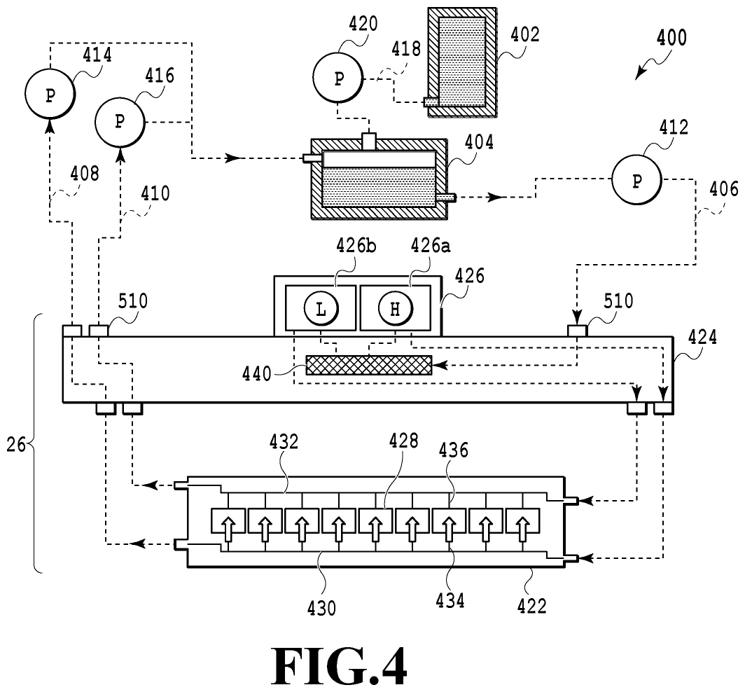

The print head 26 is configured to be capable of ejecting an ink, for example, in an inkjet method. As the inkjet method, the printing apparatus 10 may use any of various known techniques such as a method using heating elements, a method using piezoelectric elements, a method using electrostatic elements, and a method using MEMS elements. In the present embodiment, the printing apparatus 10 is configured to eject the inks in the method using heating elements. The print head 26 is supplied with the corresponding type of ink via tubes and so on from a main tank 402 (see FIG. 4) provided to the printing apparatus 10.

The print module 14 includes a maintenance section 28 configured to maintain and recover ink ejection characteristics of the print heads 26 in good conditions. The maintenance section 28 includes, for example, a cap member for protecting a nozzle surfaces in which nozzles for ejecting the inks are formed, a wiping member for wiping the nozzle surfaces, a suction member for sucking the inks in the print heads 26 via the nozzles, and so on. The print heads 26 and the maintenance section 28 are configured to mover relative to each other. For example, in the case of using the maintenance section 28, the maintenance section 28 is located below the print heads 26 at a position opposed to the nozzle surfaces. Only each of the constituent members in the maintenance section 28 may be moved.

### <Configuration of Control System of Printing Apparatus>

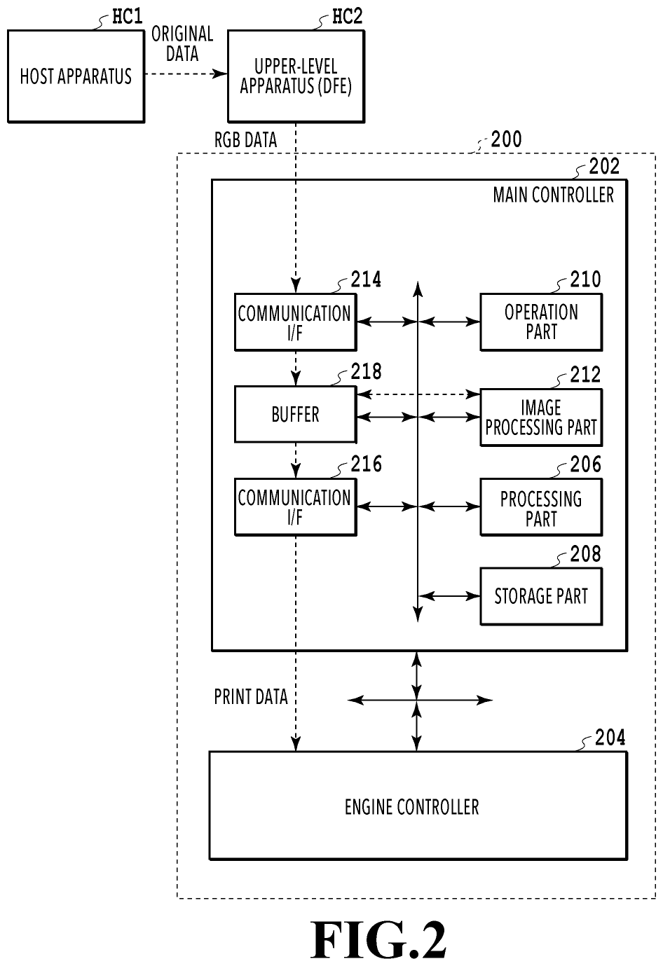

Next, a configuration of a control system of the printing apparatus 10 will be described. FIG. 2 is a block diagram illustrating the configuration of the control system of the printing apparatus 10. The printing apparatus 10 is connected to an upper-level apparatus (DFE: digital front-end) HC2 in a communication-enabled manner and the upper-level apparatus HC2 is connected to a host apparatus HC1 in a communication-enabled manner. The host apparatus HC1 creates or stores original data based on which a print image is to be formed. Here, the original data is created in the form of an electronic file such, for example, as a document file or an image file. The original data is transmitted from the host apparatus HC1 to the upper-level apparatus HC2. The upper-level apparatus HC2 converts the received original data into a data format usable by the printing apparatus 10, for example, RGB data expressing an image with RGB. The data after conversion is transmitted from the upper-level apparatus HC2 to the printing apparatus 10.

The control section 200 configured to control operations of the entire printing apparatus 10 includes a main controller 202 and an engine controller 204. The main controller 202 includes a processing part 206, a storage part 208, an operation part 210, an image processing part 212, communication interfaces (I/F) 214 and 216, and a buffer 218.

The processing part 206 is implemented by a processor such as a CPU and controls the entire main controller 202 by executing a program stored in the storage part 208. The storage part 208 is implemented by a storage device such as a ROM, a RAM, a hard disk, or an SSD, and configured to store data and the program to be executed by the processing part 206 and provide a work area to the processing part 206. The operation part 210 is, for example, an input device such as a touch panel, a key board, and a mouse, and receives instructions from a user.

The buffer 218 is a storage region implemented by, for example, a RAM, a hard disk, an SSD, or the like and configured to store various types of information. The image processing part 212 is implemented by, for example, an electronic circuit including an image processing processor and is configured to be capable of executing image processing on image data (RGB data) input from the upper-level apparatus HC2. The communication I/F 214 communicates with the upper-level apparatus HC2, while the communication I/F 216 communicates with the engine controller 204. Although the control section 200 is described which includes one processing part 206, one storage part 208, and one image processing part 212, the control section 200 may include multiple processing parts 206, multiple storage parts 208, and multiple image processing parts 212. A configuration of the engine controller 204 will be described later.

In FIG. 2, dashed-line arrows indicate an example of flows of data input to the control section 200. The image data (RGB data) received from the upper-level apparatus HC2 through the communication I/F 214 is stored in the buffer 218. The image processing part 212 reads the image data from the buffer 218, performs predetermined image processing on the read image data to generate print data for use in the engine controller 204, and again stores the print data into the buffer 218. Then, the print data stored in the buffer 218 is transmitted from the communication I/F 216 to the engine controller 204. After that, the engine controller 204 drives the print heads 26 based on the print data, so that a printing operation of executing printing on a print medium is performed.

### <Image Processing>

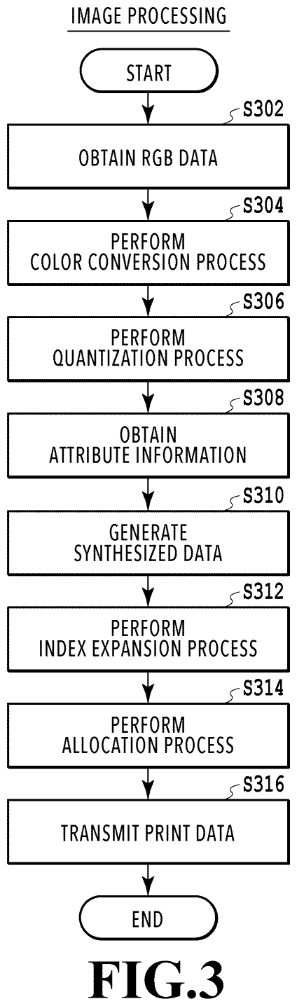

Next, the image processing executed in the image processing part 212 will be described. FIG. 3 is a flowchart presenting detailed processes in the image processing executed by the image processing part 212. The series of processes presented in the flowchart of FIG. 3 is executed by a CPU of the main controller 202 expanding program code stored in a ROM of the main controller 202 into a RAM of the main controller 202 and executing the program code. Instead, some or all of functions in steps in FIG. 3 may be executed by hardware such as an ASIC or electronic circuit. In the present specification, sign S in description of each process in a flowchart indicates a step in this flowchart.

After the start of the image processing, the image processing part 212 obtains RGB data (image data) stored in the buffer 218 in S302. In the present embodiment, in the RGB data, each RBG value is composed of 8 bits. The RGB data has a data resolution of 600 dpi×600 dpi. Next, in S304, the image processing part 212 executes a color conversion process of converting the RGB data to CMYK data corresponding to the ink colors printable by the printing apparatus 10. This color conversion process generates the CMYK data in which each CMYK value is composed of 12 bits.

After that, in S306, the image processing part 212 preforms a quantization process on the CMYK data to generate quantized data in which each CMYK value is composed of 3 bits. For this quantization process, for example, a dither method, an error diffusion method, or the like may be used. In the present embodiment, the quantization process generates the quantized data having a data resolution of 600 dpi. Then, in S308, the image processing part 212 obtains attribute information. The attribute information is 1-bit information indicating that an attribute of an image to be printed on each pixel is a character or thin line attribute or another attribute (such as an image attribute). More specifically, if a character or a thin line is to be printed on a certain pixel, “1” is obtained as the attribute information. On the other hand, if something other than a character and a thin line is to be printed, “0” is obtained as the attribute information.

Here, the process in S308 may be executed concurrently with the processes in S302 to S306. In the present embodiment, the attribute information is obtained separately from the RGB data, but an embodiment is not limited to this. The image processing part 212 may obtain data in which RGB data and attribute information are synthesized.

After obtaining the quantized data and the attribute information, the image processing part 212 synthesizes the quantized data with each CMYK value composed of 3 bits and the attribute information composed of 1 bit, thereby generating synthesized data with each CMYK value composed of 4 bits. The synthesized data thus generated has the same data resolution as that of the quantized data, that is, 600 dpi×600 dpi. In S312, the image processing part 212 performs an index expansion process on the synthesized data and generates two planes of data composed of 1-bit information on each CMYK value and the attribute information. In this index expansion, the quantized data having each CMYK value composed of 3 bits with a resolution of 600 dpi×600 dpi in the synthesized data is expanded to data having each CMYK value composed of 1 bit with a resolution of 1200 dpi×1200 dpi using index patterns.

Thereafter, in S314, the image processing part 212 performs an allocation process of allocating the expanded data to the print heads 26 configured to eject different inks, thereby generating print data to be used for printing. The print data thus generated is a set of 1-bit data with a resolution of 1200 dpi×1200 dpi for each of the CMYK colors and indicates whether or not to eject the ink. In S316, the image processing part 212 transmits the generated print data to the buffer 218 and terminates this image processing.

### <Circulation Path>

The printing apparatus 10 includes a circulation path capable of circulating an ink to supply the ink to the print head 26, collect the ink supplied to the print head 26 to outside of the print head 26, and resupply the collected ink to the print head 26. FIG. 4 is a diagram illustrating an example of a circulation path of the printing apparatus 10. FIG. 4 illustrates a circulation path for one print agent. In the printing apparatus 10 configured to eject the four different inks and the one treatment liquid, five circulation paths illustrated in FIG. 4 are provided for the respective types of the print agents.

In the printing apparatus 10, a circulation path 400 is formed in which the print head 26 is connected through channels 406, 408, and 410 to a buffer tank 404 capable of pooling the ink supplied from the main tank 402. The circulation path 400 is configured to circulate the ink between the buffer tank 404 and the print head 26 by driving three pumps 412, 414, and 416. Specifically, the channel 406 is equipped with the pump 412 and supplies the ink pooled in the buffer tank 404 to the print head 26 by driving the pump 412. The channel 408 is equipped with the pump 414 (with a relatively high pressure) and the channel 410 is equipped with the pump 416 (with a relatively low pressure). By driving these pumps 414 and 416, the ink is sucked from the print head 26 and the sucked ink is transported to the buffer tank 404.

The buffer tank 404 is provided with an air vent (not illustrated) through which the inside thereof communicates with the outside thereof and is configured to be capable of discharging air bubbles generated in the stored ink to the outside. The buffer tank 404 is connected to the main tank 402 through a channel 418. The channel 418 is provided with a pump 420. In the printing apparatus 10, for example, in a case where the ink pooled in the buffer tank 404 is reduced to a certain amount or below along with consumption of the ink by the print head 26, the pump 420 is driven to supply the ink stored in the main tank 402 to the buffer tank 404. The print head 26 consumes the ink in ejecting (discharging) the ink from the nozzles of the print head 26, such as ejecting the ink to contribute to printing and ejecting the ink not to contribute to printing.

The pumps 414 and 416 are preferably positive displacement pumps each having a constant liquid delivery capacity. Specifically, the positive displacement pumps include tube pumps, gear pumps, diaphragm pumps, syringe pumps, and the like. Alternatively, instead of such a pump, a general constant flow valve or relief valve may be placed at an outlet of the pump, thereby ensuring a constant flow rate. The channel 408 equipped with the pump 414 is connected to a common supply channel 430 (to be described later) in the print head 26, while the channel 410 equipped with the pump 416 is connected to a common collection channel 432 (to be described later) in the print head 26.

During driving of the print head 26, the ink is sucked at a certain flow rate from the common supply channel 430 and the common collection channel 432 by the pump 414 and the pump 416. The flow rate of the ink being sucked is set to a level at which a temperature variation among print element boards 428 (to be described later) in the print head 26 may not affect print quality. If too high a flow rate is set, a negative pressure variation among the print element boards 428 is too large due to an effect of pressure drops in the channels inside an ejection unit 422 (to be described later), resulting in uneven density in an image. For this reason, the flow rate is set with the temperature variation and the negative pressure variation among the print element boards 428 taken into consideration.

The print head 26 includes the ejection unit 422 configured to eject the ink and a supply unit 424 configured to supply the ink to the ejection unit 422 and collect the ink flowing out from the ejection unit 422.

The supply unit 424 supplies the ink supplied through the channel 406 to the ejection unit 422 through a negative pressure control unit 426. The negative pressure control unit 426 operates such that pressure fluctuations on a downstream side of the negative pressure control unit 426 (in other words, on an ejection unit 422 side) may be kept within a certain range even in a case where the flow rate in the circulation path changes due to a change in a print duty during printing. The pressure fluctuations are kept, for example, within the certain range centered on a preset pressure.

The negative pressure control unit 426 includes two negative pressure adjustment mechanisms 426a and 426b. The negative pressure adjustment mechanisms 426a and 426b may be any mechanisms capable of controlling the pressure on the downstream side of them within a certain fluctuation range centered on a desired set pressure. Of the negative pressure adjustment mechanisms 426a and 426b, the negative pressure adjustment mechanism 426a set with a relatively high pressure is connected to the common supply channel 430 of the ejection unit 422 via the supply unit 424. Meanwhile, the negative pressure adjustment mechanism 426b set with a relatively low pressure is connected to the common collection channel 432 of the ejection unit 422 via the supply unit 424.

In an example, the negative pressure adjustment mechanisms 426a and 426b may employ a structure similar to that of a so-called pressure reducing regulator. In the case where pressure reducing regulators are used, the circulation path 400 preferably has a structure in which the pump 412 applies a pressure to the upstream side of the negative pressure control unit 426 via the supply unit 424. Since this structure can reduce an influence of a head difference between the buffer tank 404 and the print head 26, the degree of freedom in the layout of the buffer tank 404 of the printing apparatus 10 can be increased.

The pump 412 may be any pump having a lift pressure equal to or higher than a certain pressure within a range of the ink circulation flow rate used during driving of the print head 26, and may be a turbo pump, a positive displacement pump, or the like. Specifically, a diaphragm pump or the like can be used as the pump 412. Instead of the pump 412, for example, a head tank arranged with a certain head difference from the negative pressure control unit 426 may be used.

In the ejection unit 422, multiple print element boards 428 capable of ejecting the ink are arrayed. In addition, in the ejection unit 422, the common supply channel 430 to which the ink supplied from the supply unit 424 is supplied and the common collection channel 432 through which the supplied ink flows out into the supply unit 424 extend along an array direction of the print element boards 428. The common supply channel 430 is connected to each of the print element boards 428 via a dedicated supply channel 434. The common collection channel 432 is connected to each of the print element boards 428 via a dedicated collection channel 436.

As a result, the common supply channel 430 and the common collection channel 432 communicate with each other via the dedicated supply channels 434, the print element boards 428, and the dedicated collection channels 436. Then, the common supply channel 430 is connected to the negative pressure adjustment mechanism 426a and is kept under the relatively high pressure, whereas the common collection channel 432 is connected to the negative pressure adjustment mechanism 426b and is kept under the relatively low pressure. Thus, a pressure difference occurs between these two channels. For this reason, part of the ink supplied to the common supply channel 430 flows into the common collection channel 432 through the dedicated supply channels 434, the print element boards 428, and the dedicated collection channels 436.

In the ejection unit 422 with this structure, the ink flows are generated such that the ink flows into the common supply channel 430 and the common collection channel 432, while part of the ink passes through each of the print element boards 428. Accordingly, the heat generated in each of the print element boards 428 is released to the outside of the print element board 428 by means of the ink flowing from the common supply channel 430 to the common collection channel 432. During printing by the print head 26, ink flows can be generated even in nozzles and pressure chambers that are not engaged in ejecting the ink for the printing. This makes it possible to suppress thickening of the ink in the nozzles and the pressure chambers and also makes it possible to discharge the thickened ink and foreign matters in the ink from the print element boards 428 to the outside of the print element boards 428, enabling high-speed and high-quality printing.

### <Print Head>

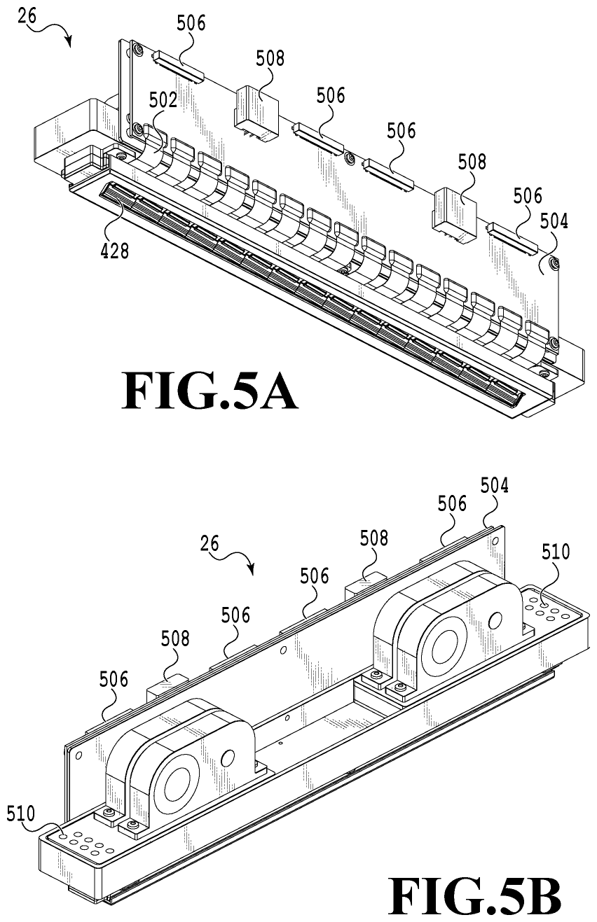

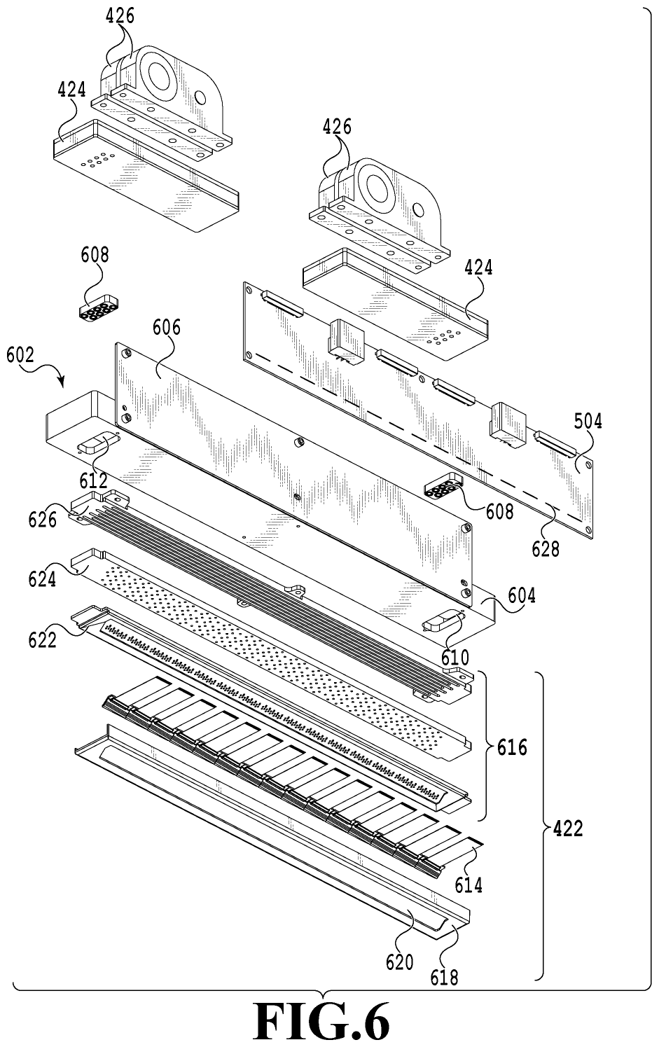

Next, a structure of the print head 26 will be described. FIGS. 5A and 5B are perspective views of the print head 26. FIG. 5A is the view seen from below on one side in the conveyance direction while FIG. 5B is the view seen from above on the other side in the conveyance direction. FIG. 6 is an exploded structural view of the print head 26. In the following description, the print head 26 capable of ejecting four types of inks will be described as an example for ease of understanding. The structure of the print head 26 is not limited to this and may be a structure capable of ejecting only one type of ink, for example. The treatment liquid is ejected from a print head that is not engaged in ejecting the inks.

In the print head 26, the multiple print element boards 428 are arrayed along an extension direction (Y direction) of the print head 26 on the surface facing a print medium conveyed in the conveyance direction by the conveyance belt 24 (see FIG. 5A). In the following description of the structure of the print head 26, the print head 26 is provided with 15 print element boards 428, and each print element board 428 is configured to be capable of ejecting four types of inks, namely, the C ink, the M ink, the Y ink, and the K ink.

The print head 26 includes signal input terminals 506 and power supply terminals 508 electrically connected to the print element boards 428 via flexible wiring boards 502 and an electric wiring board 504 (see FIGS. 5A and 5B). The signal input terminals 506 and the power supply terminals 508 are electrically connected to an electric control section (not illustrated) in the printing apparatus 10. Each of the print element boards 428 is supplied with an ejection control signal from the electric control section via the signal input terminal 506 and is supplied with power necessary for ejection from the electric control section via the power supply terminal 508.

Since the wiring is consolidated using electric circuits in the electric wiring board 504, the number of the signal input terminals 506 and the number of the power supply terminals 508 are made smaller than the number of the print element boards 428. This reduces the number of electrical connections that need to be attached or detached in mounting the print head 26 onto the printing apparatus 10 or in replacing the print head 26.

Near both ends in the extension direction, the print head 26 includes connection portions 510 to be connected to the channels in the circulation paths. From the channel in the circulation path provided for each type of ink, the ink is supplied to the print head 26 via the corresponding connection portions 510. To the channel in the circulation path provided for each type of ink, the ink flows out from the print head 26 via the corresponding connection portions 510.

The print head 26 includes a housing 602 to which the supply units 424 and the electric wiring board 504 are attached (see FIG. 6). The supply unit 424 is provided with the connection portions 510. The supply unit 424 is provided with filters 440 (see FIG. 4) for removing foreign matters in the inks supplied. In the present embodiment, the two supply units 424 are provided in the print head 26 and each include channels and filters 440 for two colors. The negative pressure control units 426 are connected to the supply unit 424 and the inks supplied to the supply unit 424 are supplied to the corresponding negative pressure control units 426.

The negative pressure control unit 426 is a unit including the negative pressure adjustment mechanisms 426a and 426b, and significantly attenuates, by an action of a valve, a spring member, and the like provided inside, a pressure drop change in the circulation path that occurs with fluctuations of the flow rate of the link. For this purpose, the two negative pressure adjustment mechanisms 426a and 426b are set with different control pressures, the negative pressure adjustment mechanism 426a with the relatively high pressure is connected to the common supply channel 430 of the ejection unit 422, and the negative pressure adjustment mechanism 426b with the relatively low pressure is connected to the common collection channel 432 of the ejection unit 422.

The housing 602 includes an ejection unit support portion 604 for supporting the ejection unit 422 and an electric wiring board support portion 606 for supporting the electric wiring board 504, and ensures the rigidity of the print head 26. The electric wiring board support portion 606 is fixed to the ejection unit support portion 604 by screwing. The ejection unit support portion 604 corrects warping or deformation of the ejection units 422 and thereby ensures the accuracy of relative positions of the multiple print element boards 428. This reduces streaks and unevenness in printed images due to the accuracy of relative positions. For this purpose, the ejection unit support portion 604 preferably has a sufficient rigidity and, for example, a metallic material such as stainless used steel (SUS) or aluminum or a ceramic such as alumina is preferably used as a material for the ejection unit support portion 604. In addition, the ejection unit support portion 604 is provided with holes 610 and 612 to which joint rubbers 608 are to be inserted. The inks supplied from the supply units 424 are guided to a third channel member 626 (to be described later) of the ejection unit 422 via the joint rubbers 608.

The ejection unit 422 includes ejection modules 614 each including the print element board 428 and a channel member 616 to distribute the inks from the supply units 424 to the print element boards 428 and guide the inks flowing out from the print element boards 428 to the supply units 424. The ejection unit 422 also includes a cover member 618 for protecting the surroundings of the arrayed print element boards 428.

Each ejection module 614 includes the print element board 428 and the flexible wiring board 502, which will be described in detail later. The channel member 616 is formed by stacking a first channel member 622, a second channel member 624, and the third channel member 626. The channel member 616 is fixed to the ejection unit support portion 604 by screwing, which suppresses warping or deformation of the channel member 616.

The cover member 618 is a member including a frame-shaped surface provided with an opening 620 that opens long in the extension direction of the print head 26. The print element boards 428 and sealants 710 (to be described later) of the ejection modules 614 are exposed from the opening 620. A frame portion around the opening 620 is a surface to be in contact with the cap member (not illustrated) of the maintenance section 28. For this reason, an adhesive, a sealant, a filler, or the like is applied to the area around the opening 620 to fill in any irregularities or gaps on the surface where the print element boards 428 in the ejection unit 422 are exposed, so that a closed space can be formed between that surface and the cap member in capping.

### <Ejection Module>

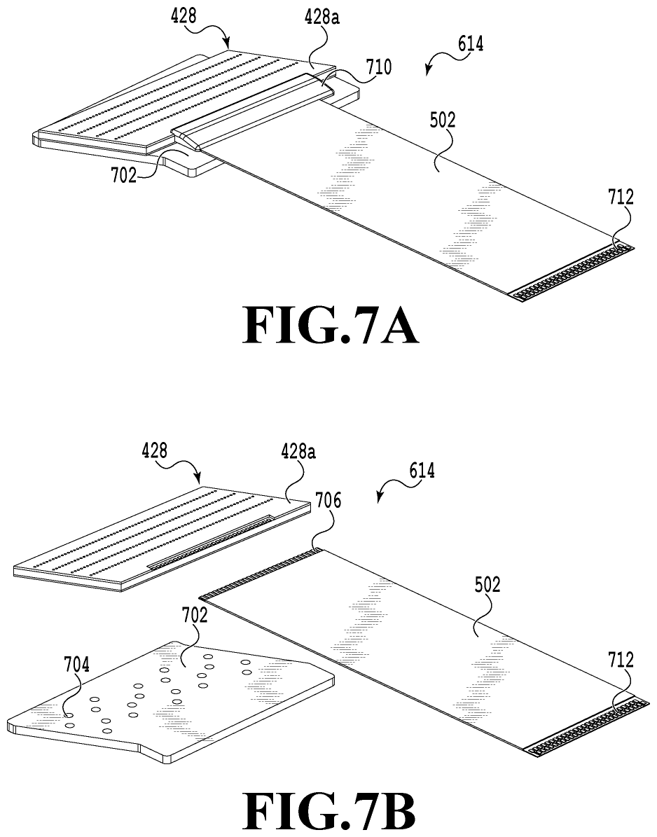

Next, the ejection module 614 will be described. FIGS. 7A and 7B are schematic structural views of the ejection module 614. FIG. 7A is a perspective view while FIG. 7B is an exploded schematic structural view.

The ejection module 614 includes the print element board 428, the flexible wiring board 502 electrically connecting the print element board 428 to the electric wiring board 504, and a support member 702 supporting the print element board 428 and one end of the flexible wiring board 502. The support member 702 is provided with communication holes 704 that communicate with apertures 1004 (to be described later) provided in the print element board 428.

A surface of the print element board 428 opposite to a nozzle formation surface 428a is bonded to the support member 702 such that the apertures 1004 of the print element board 428 communicate with the communication holes 704. The one end of the flexible wiring board 502 provided with terminals 706 is electrically connected by wire-bonding to terminals 1022 (to be described later) formed on the nozzle formation surface 428a of the print element board 428 while being supported by the support member 702. The wire-bonding portion, in other words, the electric connection portion is sealed by the sealant 710.

The other end of the flexible wiring board 502 is provided with terminals 712 and the terminals 712 are electrically connected to connection terminals 628 (see FIG. 6) on the electric wiring board 504. The support member 702 functions as a supporting body that supports the print element board 428 and also functions as a channel member through which the print element board 428 and the channel member 616 fluidly communicate with each other. For this purpose, the support member 702 is preferably made of a material that has a high degree of flatness and that can be joined to the print element board 428 with sufficiently high reliability. Specifically, the support member 702 is made of, for example, alumina or a resin material.

### <Channel Member>

Next, a detailed structure of the channel member 616 will be described.

### =First Channel Member 622, Second Channel Member 624, and Third Channel Member 626=

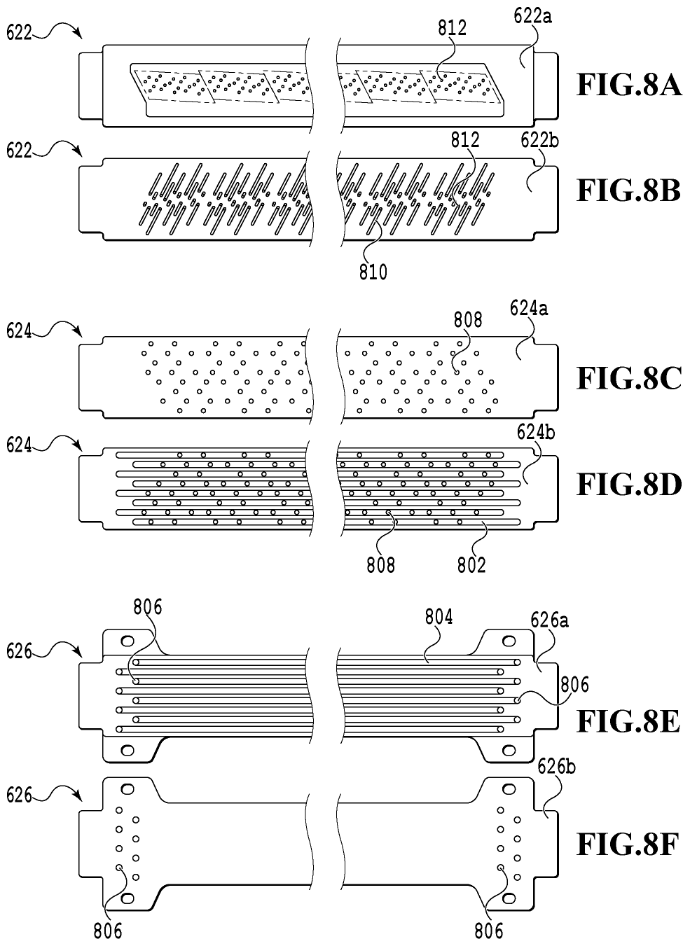

First, structures of the first channel member 622, the second channel member 624, and the third channel member 626 in the channel member 616 will be described. FIGS. 8A to 8F are structural views of the first channel member 622, the second channel member 624, and the third channel member 626. FIG. 8A is the view illustrating a one-side surface 622a of the first channel member 622 on which the ejection modules 614 are arranged and FIG. 8B is the view illustrating an other-side surface 622b of the first channel member 622 to be joined to a one-side surface 624a of the second channel member 624. FIG. 8C is the view illustrating the one-side surface 624a of the second channel member 624 and FIG. 8D is the view illustrating an other-side surface 624b of the second channel member 624 to be joined to a one-side surface 626a of the third channel member 626. FIG. 8E is the view illustrating the one-side surface 626a of the third channel member 626 and FIG. 8F is a view illustrating an other-side surface 626b of the third channel member 626 to be brought into contact with the ejection unit support portion 604.

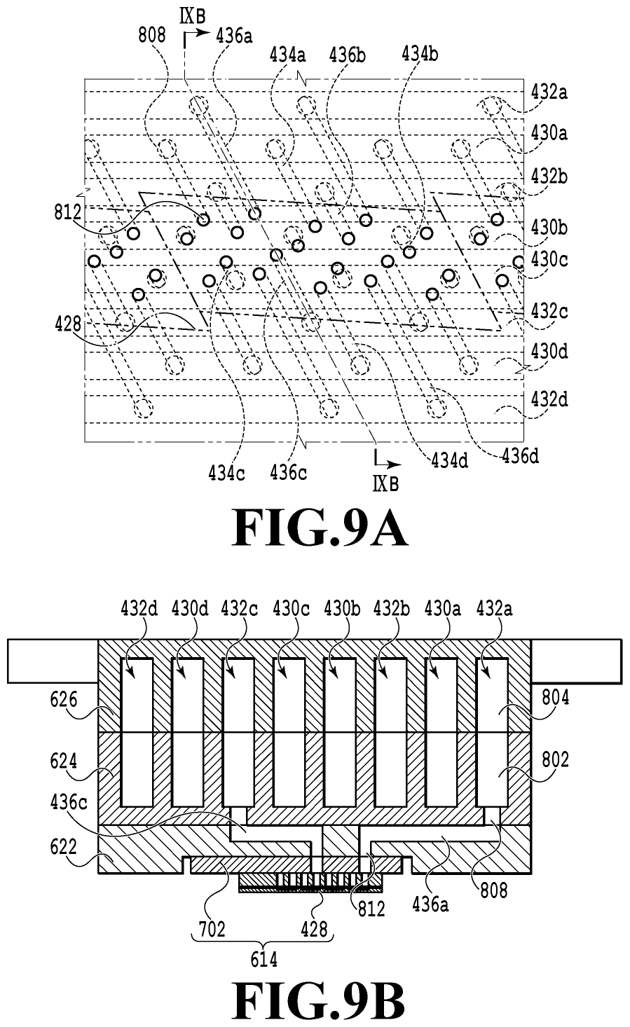

In the other-side surface 624b of the second channel member 624, multiple (eight in FIG. 8D) common channel grooves 802 are formed along the extension direction of the second channel member 624 (see FIG. 8D). In the one-side surface 626a of the third channel member 626, common channel grooves 804 are formed (see FIG. 8E). The common channel grooves 804 are provided as many as the common channel grooves 802 at positions corresponding to the respective common channel grooves 802 provided in the other-side surface 624b in the case where the one-side surface 626a of the third channel member 626 is joined to the other-side surface 624b of the second channel member 624. As a result, in the case where the second channel member 624 and the third channel member 626 are joined together, the common channel grooves 802 and the common channel grooves 804 form eight common channels. These common channels serve as the common supply channels 430 and the common collection channels 432 formed for the respective inks (see FIGS. 9A and 9B).

The third channel member 626 is provided with communication holes 806 penetrating from the one-side surface 626a to the other-side surface 626b (see FIGS. 8E and 8F). These communication holes 806 are provided on both end sides of the third channel member 626 in the extension direction. In the one-side surface 626a, the communication holes 806 are located at both ends of each of the common channel grooves 804. In a case where the third channel member 626 is fixed to the ejection unit support portion 604, the communication holes 806 communicate with channels (not illustrated) provided in the joint rubbers 608 and fluidly connect the third channel member 626 to the supply units 424.

The second channel member 624 is provided with communication holes 808 penetrating from the one-side surface 624a to the other-side surface 624b (see FIGS. 8C and 8D). Multiple communication holes 808 are provided in each of the common channel grooves 802 and formed at positions at which the communication holes 808 communicate with dedicated channel grooves 810 (to be described later) provided in the first channel member 622 in the case where the second channel member 624 and the first channel member 622 are joined together.

In the first channel member 622, the other-side surface 622b is provided with the dedicated channel grooves 810 formed so as to incline with respect to a short-side direction of the first channel member 622 (the direction orthogonal to the extension direction of the first channel member 622) (see FIG. 8B). In addition, the first channel member 622 is provided with communication holes 812 penetrating from the one-side surface 622a to the other-side surface 622b (see FIGS. 8A and 8B). These communication holes 812 are located in a center region of the first channel member 622 in the short-side direction. The communication holes 812 are provided at positions at which the communication holes 812 fluidly communicate with the print element boards 428 via the communication holes 704 of the support members 702 in the case where the ejection modules 614 are arranged on the one-side surface 622a of the first channel member 622. The communication holes 812 are located at one ends of the dedicated channel grooves 810. The other ends of the dedicated channel grooves 810 communicate with the communication holes 808.

The first channel member 622, the second channel member 624, and the third channel member 626 are preferably made of a material having corrosion resistance to the inks and a low linear expansion coefficient. For example, as a specific material, it is possible to use a composite material (resin material) in which alumina, liquid crystal polymer (LCP), polyphenyl sulfide (PPS), or polysulfone (PSF) is used as a base material and inorganic fillers such as silica microparticles or fibers are added. The channel member 616 is formed by stacking and bonding the first channel member 622, the second channel member 624, and the third channel member 626 together. In the case where the first channel member 622, the second channel member 624, and the third channel member 626 are formed of a resin composite material, these members may be joined by welding.

### =Channels in Channel Member=

Next, the channels formed in the channel member 616 will be described. FIGS. 9A and 9B are views illustrating channels formed in the channel member 616. FIG. 9A is a partially enlarged view while FIG. 9B is a cross-sectional view taken along a IXB-IXB line in FIG. 9A. FIG. 9A is the view seen from the one-side surface 622a of the first channel member 622, in which the channels formed inside are illustrated with dash lines and the print element boards 428 arranged on the upper side are illustrated with dash-double-dot lines.

In the channel member 616, the common supply channels 430 and the common collection channels 432 extending in the longitudinal direction of the print head 26 are provided for the respective inks (see FIG. 9A). In FIG. 9A, the common supply channel 430a and the common collection channel 432a are for the same ink, and the common supply channel 430b and the common collection channel 432b are for the same ink. Then, the common supply channel 430c and the common collection channel 432c are for the same ink, and the common supply channel 430d and the common collection channel 432d are for the same ink.

Multiple dedicated supply channels 434 formed by the dedicated channel grooves 810 are connected to each common supply channel 430 via the communication holes 808. Specifically, dedicated supply channels 434a are connected to the common supply channel 430a via the communication holes 808 and dedicated supply channels 434b are connected to the common supply channel 430b via the communication holes 808. Then, dedicated supply channels 434c are connected to the common supply channel 430c via the communication holes 808 and dedicated supply channels 434d are connected to the common supply channel 430d via the communication holes 808.

Multiple dedicated collection channels 436 formed by the dedicated channel grooves 810 are connected to each common collection channel 432 via the communication holes 808. Specifically, dedicated collection channels 436a are connected to the common collection channel 432a via the communication holes 808 and dedicated collection channels 436b are connected to the common collection channel 432b via the communication holes 808. Then, dedicated collection channels 436c are connected to the common collection channel 432c via the communication holes 808 and dedicated collection channels 436d are connected to the common collection channel 432d via the communication holes 808.

With this structure, the common supply channel 430 can be fluidly connected via the dedicated supply channels 434 and the common collection channel 432 can be fluidly connected via the dedicated collection channels 436 to the print element boards 428 arranged on a center portion of the channel member 616.

In the case where the ejection modules 614 are arranged on the channel member 616, the dedicated collection channels 436 communicate with the ejection modules 614 via the communication holes 812 (see FIG. 9B). In the case where the ejection modules 614 are arranged on the channel member 616, the dedicated supply channels 434 also communicate with the ejection modules 614 via the communication holes 812, although an cross sectional view thereof is omitted herein.

Thus, the channel member 616 is fluidly connected via the support members 702 to pressure chambers 1120 (to be described later) provided in the print element boards 428. In each pressure chamber 1120, a print element 1118 and a nozzle 1002 are arranged as will be described later.

Here, the common supply channel 430 is connected to the negative pressure control unit 426 (negative pressure adjustment mechanism 426a) via the supply unit 424 and the common collection channel 432 is connected to the negative pressure control unit 426 (negative pressure adjustment mechanism 426b) via the supply unit 424. Thus, the negative pressure control unit 426 generates a pressure difference between the common supply channel 430 and the common collection channel 432. As a result, in the print head 26, for each ink, part of the supplied ink flows in the following order: the common supply channel 430, the dedicated supply channels 434, the print element boards 428, the dedicated collection channels 436, and the common collection channel 432.

### <Channel Structure in Print Element Board>

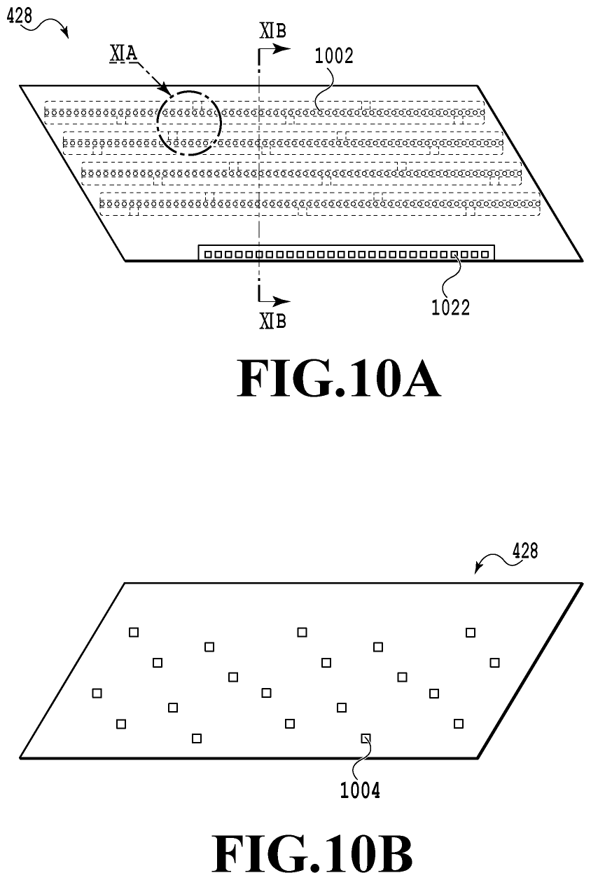

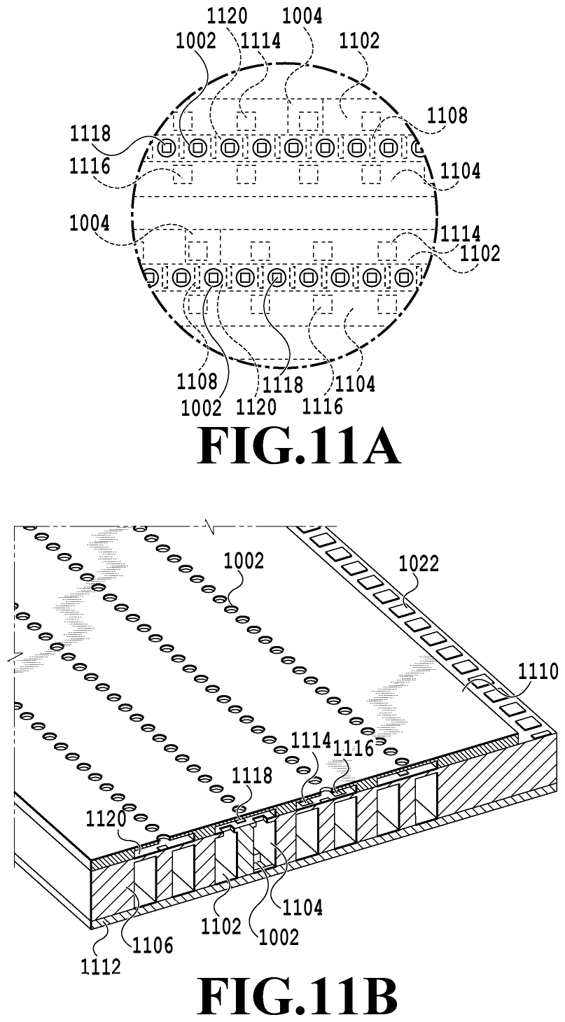

Next, a channel structure in the print element board 428 will be described. FIGS. 10A and 10B are external appearance views of the print element board 428. FIG. 10A is the view seen from the nozzle formation surface in which the nozzles are formed while FIG. 10B is the view seen from the contact surface to be brought into contact with the support member 702. FIGS. 11A and 11B are views illustrating a channel structure of the print element board 428. FIG. 11A is an enlarged view of an area in a frame XIA in FIG. 10A while FIG. 11B is a cross-sectional view taken along an XIB-XIB line in FIG. 10A.

In the print element board 428, four nozzle arrays for the respective inks are formed in a one-side surface (see FIG. 10A). In each nozzle array, multiple nozzles 1002 are arrayed along the extension direction of the print element board 428. In the print element board 428, the other-side surface opposite to the one-side surface is provided with the apertures 1004 to be fluidly connected to the communication holes 704 of the support member 702 (see FIG. 10B).

The print element board 428 includes a board 1106 in which supply paths 1102 for supplying the inks to pressure chambers 1120 (to be described later) and collection paths 1104 for collecting the inks from the pressure chambers 1120 are formed (see FIG. 11B). On the one-side surface of this board 1106, a nozzle formation member 1110 is provided in which the nozzle arrays composed of the multiple nozzles 1002 for ejecting the inks are formed. The board 1106 is formed of, for example, silicon (Si), while the nozzle formation member 1110 is formed of, for example, a photosensitive resin. On the other-side surface of the board 1106 opposite to the one-side surface, a cover plate 1112 is formed.

The supply paths 1102 and the collection paths 1104 extend along the extension direction of the nozzle arrays in the nozzle formation member 1110 (see FIG. 11A). The supply path 1102 is arranged on one side of each nozzle array in a short-side direction of the print element board 428 and the collection path 1104 is arranged on the other side of each nozzle array in the short-side direction. In the one-side surface of the board 1106, multiple supply ports 1114 communicating with each supply path 1102 are arrayed along the extension direction of the nozzle array. Moreover, in the one-side surface of the board 1106, multiple collection ports 1116 communicating with each collection path 1104 are arrayed along the extension direction of the nozzle array.

The one-side surface of the board 1106 is provided with a print element 1118 at a position opposed to each nozzle 1002. The print element 1118 is a heating element to cause the ink to bubble with thermal energy (electrothermal transducer element). In the present embodiment, the print element 1118 functions as an energy generation element to generate energy for ejecting the ink from the nozzle. This print element 1118 is located inside each of the pressure chambers 1120 formed in the nozzle formation member 1110. For each print element 1118, this pressure chamber 1120 is formed by a partition wall 1108. In addition, the one-side surface of the board 1106 is provided with terminals 1022 electrically connected to the print elements 1118 via electric wiring (not illustrated) provided in the board 1106. Thus, each of the print elements 1118 generates heat based on an ejection control signal input via the electric wiring board 504 and the flexible wiring board 502, thereby boiling the ink inside the pressure chamber 1120. The force of a bubble generated by this boiling causes the ink in the pressure chamber 1120 to be ejected from the nozzle 1002.

The cover plate 1112 is provided with the apertures 1004 communicating with the supply paths 1102 and the collection paths 1104. Each supply path 1102 is supplied with the ink from the apertures 1004 communicating with the supply path 1102 while the ink in each collection path 1104 flows out into the apertures 1004 communicating with the collection path 1104. In the present embodiment, three apertures 1004 are formed for each supply path 1102 and two apertures 1004 are formed for each collection path 1104. The cover plate 1112 also functions as a lid forming parts of the supply paths 1102 and the collection paths 1104 formed in the board 1106. The cover plate 1112 is required to have sufficient corrosion resistance to the inks, and the aperture shapes and aperture positions of the apertures 1004 are required to achieve high precision from the standpoint of preventing color mixing. To this end, it is preferable to use, as a material for the cover plate 1112, a photosensitive resin material or a silicon plate, and provide the apertures 1004 by a photolithography process. Thus, the cover plate 1112 serves to convert the pitch between the channels by using the apertures 1004, preferably has a small thickness with a pressure drop taken into consideration, and is composed of, for example, a film-shaped member.

In the print element board 428, the supply path 1102 is connected to the common supply channel 430 and the collection path 1104 is connected to the common collection channel 432, so that a pressure difference is generated between the supply path 1102 and the collection path 1104. During circulation of the ink inside the circulation path, this pressure difference causes the ink to flow from the supply path 1102 to the collection path 1104 through the supply ports 1114, the pressure chambers 1120, and the collection ports 1116. Through this flow, for example, from the nozzles 1002 and the pressure chambers 1120 not engaged in a printing operation, the thickened ink generated by evaporation through the nozzles 1002, bubbles, foreign matters, and so on can be caused to flow out into the collection path 1104. In addition, this flow suppresses thickening of the ink in the nozzles 1002 and the pressure chambers 1120. The ink flowing out into the collection path 1104 is collected by the channel member 616 through the apertures 1004 in the cover plate 1112 and the communication holes 704 in the support member 702.

The inks supplied to the print head 26 flow into the communication holes 812 through the joint rubbers 608, the communication holes 806 in the third channel member 626, the communication holes 808 in the second channel member 624, and the dedicated supply channels 434 in the first channel member 622. After that, the inks flow into the pressure chambers 1120 through the communication holes 704 in the support member 702, the apertures 1004 in the cover plate 1112, and the supply paths 1102 provided in the board 1106.

Of the inks supplied to the pressure chambers 1120, the inks not ejected from the nozzles 1002 flow into the collection ports 1116 and the collection paths 1104 in the board 1106, the apertures 1004 in the cover plate 1112, and then the communication holes 704 in the support member 702. After that, the inks pass through the communication holes 812 in the first channel member 622, the dedicated collection channels 436, the communication holes 808 in the second channel member 624, the common collection channels 432, and the communication holes 806 in the third channel member 626, and then flow into the joint rubbers 608. Then, the inks flow out into the outside of the print head 26 through the connection portions 510 provided in the supply units 424.

In each circulation path in the present embodiment, not all of the ink flowing into the common supply channel 430 in the ejection unit 422 is supplied to the pressure chambers 1120 via the dedicated supply channels 434. Part of the ink flows out from the common supply channel 430 to the supply unit 424 without entering the dedicated supply channels 434. In the case where a path through which the ink flows while bypassing the print element boards 428 is provided as described above, it is possible to suppress a backflow of the circulating flow of the ink even if the print element boards 428 having fine channels with high flow resistance are used. Therefore, the print head 26 according to the present embodiment can suppress thickening of the ink near the pressure chambers 1120 and the nozzles 1002, thereby suppressing a deviation of an ejection direction from a proper direction and non-ejection and enabling high-quality printing.

### <Positional Relationship Between Print Element Boards>

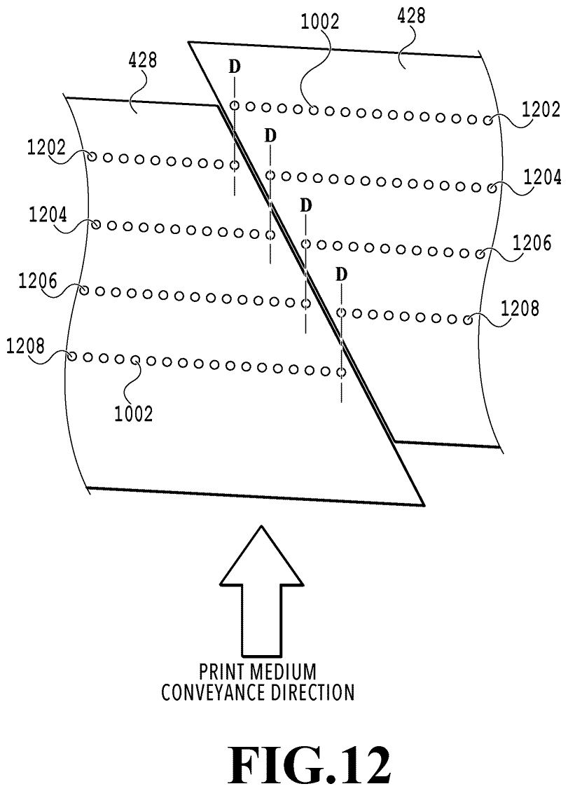

Next, description will be given of a positional relationship between the adjacent print element boards 428 among the multiple print element boards 428 arrayed in the extension direction of the print head 26. FIG. 12 is a view illustrating a positional relationship between the adjacent print element boards 428.

The print element boards 428 are each formed in a substantially parallelogram shape (see FIG. 10A) and each of nozzle arrays 1202, 1204, 1206, and 1208 is inclined at a predetermined angle with respect to the print medium conveyance direction. The adjacent print element boards 428 are arranged such that one nozzle 1002 in one of the corresponding nozzle arrays overlaps with one nozzle 1002 in the other corresponding nozzle array in the print medium conveyance direction (see dashed-dotted lines in FIG. 12). The number of nozzles overlapping in the conveyance direction is not limited to one but may be two or more.

In the case where the adjacent print element boards 428 are arranged in this way, even if the positions of the print element boards 428 are slightly misaligned from predetermined positions, a black streak or white space that may appear in a printed image can be made less visually-noticeable by driving control of the overlapping nozzles. Also in the case where the print element boards 428 are arranged in a linear pattern (in-line) instead of a staggered pattern, the print element boards 428 may be arranged as in FIG. 12. In the present embodiment, the print element boards 428 are each formed in a substantially parallelogram shape, but their shape is not limited to this. For example, the shape may be a quadrilateral shape having longitudinal sides and short sides such as a rectangle or a trapezoid or any of various known shapes.

<Structure around Heat Application Part in Print Element Board>

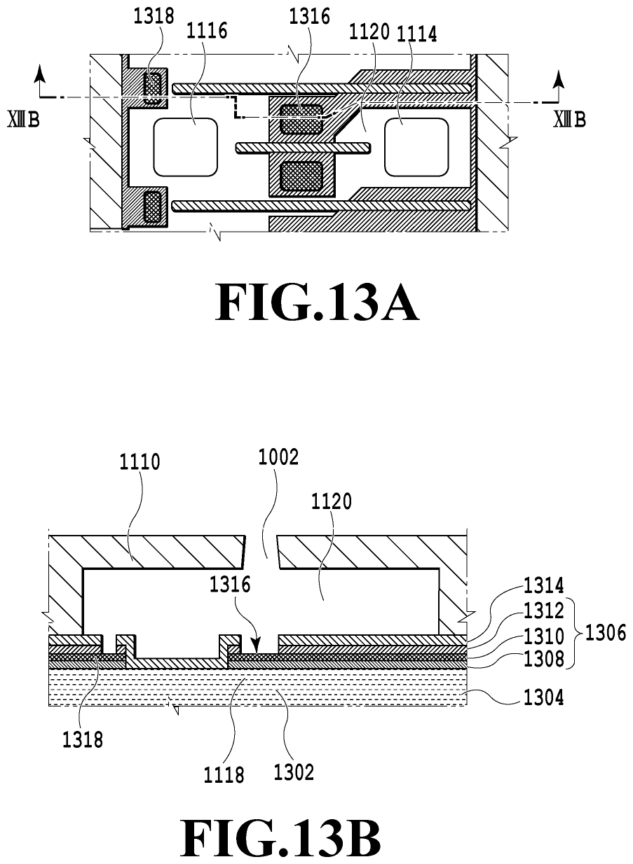

Next, description will be given of a structure around the print element 1118, which is a heat application part in the print element board 428. FIGS. 13A and 13B are views illustrating the structure around the print element 1118 in the print element board 428. FIG. 13A is a view illustrating a structure inside the pressure chamber 1120. FIG. 13B is a cross-sectional view taken along a line XIIIB-XIIIB in FIG. 13A.

In the print element board 428, the board 1106 on which the nozzle formation member 1110 is stacked is formed by stacking constituents such as wiring and the print element 1118 onto a base plate (not illustrated). In the present embodiment, an insulating heat accumulation layer 1304 formed of a thermal oxide film, an SiO film, an SiN film, or the like is formed on the base plate. The print element 1118 is arranged in the heat accumulation layer 1304. To the print element 1118, an electrode wiring layer (not illustrated) as wiring formed of a metal material such as Al, Al—Si, or Al—Cu is connected via a tungsten plug 1302. On the print element 1118, an insulating protective layer is formed by the heat accumulation layer 1304.

On the foregoing insulating protective layer (the uppermost layer in the heat accumulation layer 1304), a protective layer 1306 is formed which prevents the insulating protective layer from coming into contact with the ink inside the pressure chamber 1120. This protective layer 1306 includes a lower protective layer 1308, an upper protective layer 1310, and an adhesive protective layer 1312 and protects the surface of the print element 1118 from chemical and physical shocks associated with heat generation of the print element 1118. For example, the lower protective layer 1308 is formed of tantalum (Ta), the upper protective layer 1310 is formed of iridium (Ir), and the adhesive protective layer 1312 is formed of tantalum (Ta). Thus, the protective layer 1306 has conductivity.

A protective layer 1314 is provided on the adhesive protective layer 1312 in order to improve the resistance to the ink and improve adhesion to the nozzle formation member 1110. The protective layer 1314 is preferably formed of a film hardly soluble in the ink such as SiCN/SiOC. In most of an area of the protective layer 1306 above the print element 1118, the upper protective layer 1310 is exposed inside the pressure chamber 1120 because the adhesive protective layer 1312 and the protective layer 1314 are not formed.

The upper protective layer 1310 is formed of a material containing a metal that can dissolve into the ink in the pressure chamber 1120 through an electrochemical reaction and that may not form, with heating, an oxide film that prevents the dissolution. In ejection of the ink from the nozzle 1002, the ink in the pressure chamber 1120 is in contact with the surface of the upper protective layer 1310 and driving of the print element 1118 leads to the occurrence of cavitation in which a bubble of the ink is generated and then collapsed due to an instantaneous rise in the temperature on that surface. For this reason, in the present embodiment, the upper protective layer 1310 is formed of iridium having high corrosion resistance and high reliability so as to come into contact with the ink above the print element 1118.

### <Kogation-Related Processes>

The print element board 428 is configured to be capable of suppressing and removing kogation that accumulates on the upper protective layer 1310 along with driving of the print element 1118. Kogation occurs as a coloring material, additives, and the like contained in the ink are heated to high temperature, decomposed at the molecular level and turned into a hardly-soluble substance, which is then physically adsorbed onto the surface of the upper protective layer 1310. As kogation accumulates on the upper protective layer 1310, the efficiency of converting thermal energy into ejection energy decreases, causing a shortage of ejection power, that is, a decrease in the ejection speed.

### =Kogation Suppression=

In the print element board 428, in order to suppress kogation, an electric field is formed in the pressure chamber 1120 by using an area of the upper protective layer 1310 directly above the print element 1118 as an electrode 1316, and providing a counter electrode 1318 corresponding to the electrode 1316 near the collection port 1116 (see FIGS. 13A and 13B). Here, the electrode 1316 functions as a negative electrode during a printing operation. This makes it possible to keep particles of a pigment or the like charged at negative potential in the ink away from the surface of the electrode 1316, that is, the surface of the upper protective layer 1310 above the print element 1118.

In the case where a presence rate of particles charged at negative potential (hereinafter also referred to as “negatively charged particles”) near the surface of the upper protective layer 1310 is reduced as described above, an accumulation of kogation during a printing operation can be suppressed on the surface of the upper protective layer 1310 above the print element 1118. In other words, in the print element board 428, in the case where the upper protective layer 1310 is heated to high temperature, occurrence of kogation is suppressed by reducing the presence rate of the coloring material, the additives, and the like, which may cause kogation, near the surface of the upper protective layer 1310.

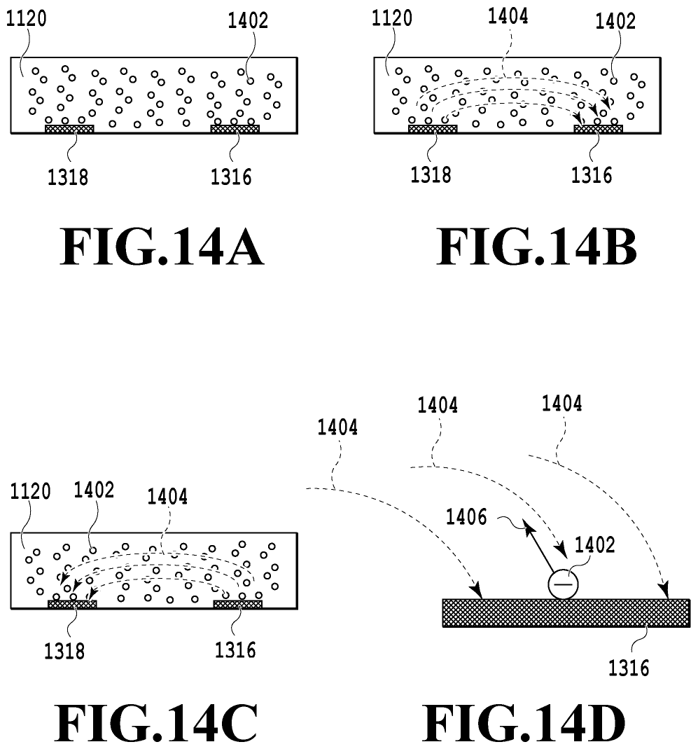

Here, a mechanism of electric field control (potential control) for kogation suppression in the present embodiment will be described in reference to FIGS. 14A to 14D. FIGS. 14A to 14D are diagrams illustrating electric fields and negatively charged particles in a state under potential control and a state without potential control. In the state where no potential control is performed between the electrode 1316 and the counter electrode 1318, negatively charged particles 1402 in the ink in the pressure chamber 1120 are substantially uniformly dispersed in the ink as in FIG. 14A.

In the case where a voltage is applied so as to make the potential of the electrode 1316 lower than the potential of the counter electrode 1318, the negatively charged particles behave as in FIG. 14B. In this case, the potential difference between the electrode 1316 and the counter electrode 1318 is about 0.5 to 2.5 V. Regarding this potential difference, in the case where the upper protective layer 1310 is formed of iridium, the surface of the electrode 1316 will dissolve into the ink if the potential difference between the two electrodes exceeds 2.5 V. For this reason, the potential difference is set to a level at which the electrode 1316 will not dissolve into the ink. In sum, in the present embodiment, it is preferable that the absolute values of ΔVp and ΔVa be 2.5 V or less, where ΔVp denotes the potential difference between the electrode 1316 and the counter electrode 1318 during a printing operation and ΔVa denotes the potential difference between the electrode 1316 and the counter electrode 1318 during aging.

In FIG. 14B, an electric field 1404 is formed via the ink between the electrode 1316 and the counter electrode 1318, but no electric current flows. Since the electrode 1316 has a negative potential relative to the potential of the counter electrode 1318, the negatively charged particles 1402 are repelled from the surface of the electrode 1316 and the presence rate of the negatively charged particles 1402 near the surface of the electrode 1316 is reduced. The negatively charged particles 1402 receive repulsive force 1406 from the surface of the electrode 1316 along lines of electric force of the electric field 1404 formed in the ink (see FIG. 14D). Owing to this mechanism, the larger the potential difference ΔV (=Vc−Vh) where Vc denotes the potential of the counter electrode 1318 and Vh denotes the potential of the electrode 1316, the more the negatively charged particles 1402 that may cause kogation are repelled from the electrode 1316, making it more difficult for kogation to occur on the electrode 1316.

### =Kogation Removal=

Kogation adhering to the electrode 1316, in other words, the kogation adhering near the surface of the upper protective layer 1310 is removed by applying a voltage between the electrode 1316 and the counter electrode 1318 to dissolve a surface layer portion of the upper protective layer 1310 into the ink, thereby lifting off the kogation. In this removal, a voltage of 3 V or higher, at which the electrode material iridium will dissolve, is applied between the electrode 1316 and the counter electrode 1318. Here, it is preferable to apply the voltage to the electrode 1316 while reversing the direction of the voltage. By removing the kogation in this manner, the surface of the electrode 1316 is made almost free of kogation.

### =Aging (Kogation Adhesion)=

Moreover, the print element board 428 is configured to be capable of performing aging in which the print element 1118 is driven to turn the upper protective layer 1310 with no kogation adhesion (or nearly no kogation adhesion) into a state with an adequate degree of kogation adhesion. Regarding a timing for aging, the aging may be performed at the start to use a brand new printing apparatus 10 that has no ejection history, after kogation removal from the upper protective layer 1310, or the like.

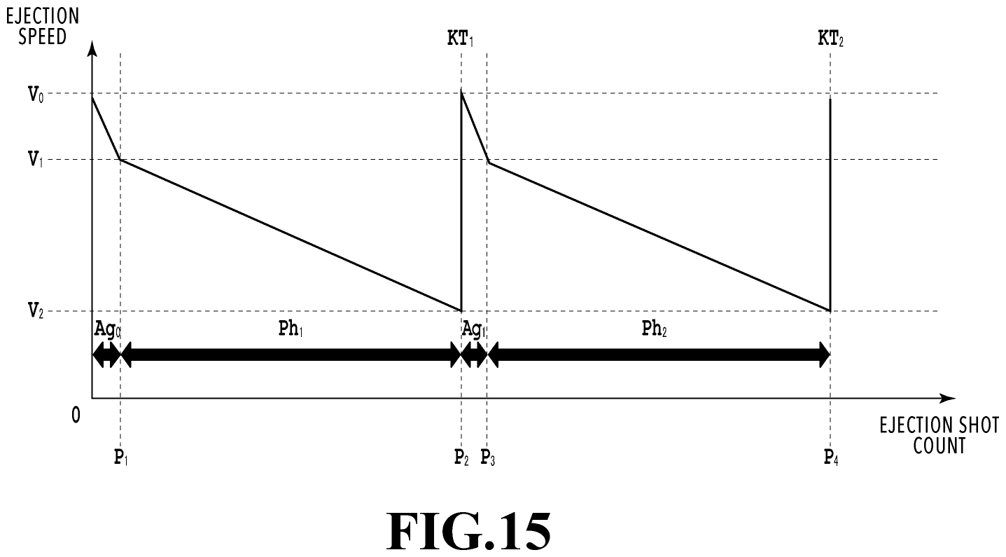

FIG. 15 is graph presenting a relationship between an ejection shot count and an ejection speed in performing aging and kogation removal. In FIG. 15, the horizontal axis indicates the ejection shot count and the vertical axis indicates the ejection speed. In FIG. 15, Agn (n is a positive integer including 0) indicates an aging execution period and KTn (n is a natural number) indicates a kogation removal execution timing. Moreover, in FIG. 15, P denotes an ejection shot count in aging, Phn denotes a normal printing period from a timing at the end of aging to a timing at which kogation removal is required, and P2n-P(2n-1) denotes an ejection shot count in Phn. Here, n is a natural number.

As presented in FIG. 15, the ejection speed is increased to near V0 by kogation removal, and this excessively increased ejection speed is reduced to V1 by performing aging, so that the subsequent ejection speed can undergo a gentle change (also referred to as “be stabilized” in the following description). The behavior of the ejection speed is related to the amount of kogation adhering to the surface of the upper protective layer 1310. In other words, the vertical axis in FIG. 15 corresponds to the amount of kogation adhesion and indicates that the lower the ejection speed, the larger the amount of kogation adhesion.

### =Conditions in Each Phase=

For aging, Vp≥0 and ΔVa<ΔVp are set. Here, ΔVp is a value obtained by subtracting a potential Vph of the electrode 1316 during the printing operation from a potential Vpc of the counter electrode 1318 during the printing operation. Then, ΔVa is a value obtained by subtracting a potential Vah of the electrode 1316 during aging from a potential Vac of the counter electrode 1318 during aging. Use of A Va (smaller than ΔVp) as the potential difference during aging makes it easier for kogation to adhere to the upper protective layer 1310 than in the case where ΔVp is used (see FIG. 14C).

In addition, during aging, in order to further accelerate the change in the ejection characteristics, that is, to promote kogation adhesion, pulses with a larger voltage value than that of voltage pulses used during normal operations such as a printing operation may be applied, as long as such pulses will not damage the print element 1118. Moreover, during aging, a pulse application time period may be made longer than in normal operations. In the present embodiment, the print element 1118 is driven during aging under the conditions (driving conditions for aging driving to be described later) that make kogation more easily adhere to the surface of the upper protective layer 1310 than the conditions in a normal printing operation. Further, during aging, the ejection speed can be stabilized if the print element 1118 ejects the ink at approximately 5×10⁵ shots (an ejection shot count during aging to be described later) per nozzle. In this case, the weight of the ink ejected is about 150 g.

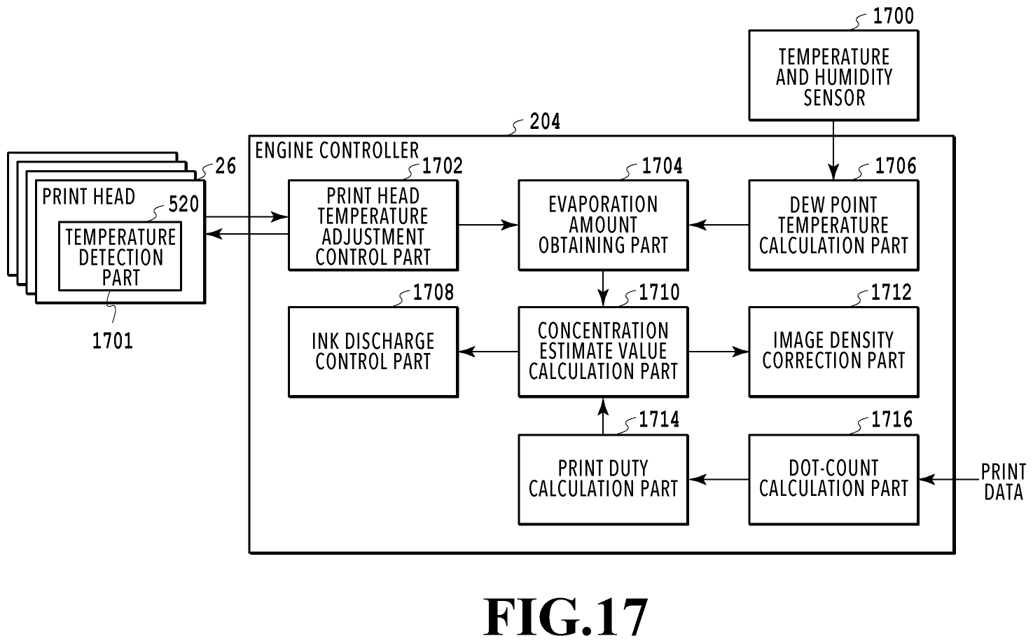

On the other hand, a timing for kogation removal arrives in the case where the ejection speed decreases to V2 as a result of ejecting the ink, for example, at approximately 5×10⁸ shots per nozzle from the state where the aging is completed. The timing for kogation removal is, for example, a timing at which the ejection characteristics deteriorate to a level at which the quality of a printed product decreases due to kogation adhering to the upper protective layer 1310. Therefore, in the present embodiment, the timing for kogation removal is set to arrive in the case where the ejection shot count P2n-P(2n-1) in the normal printing period Phn reaches 5×10⁸ after execution of the aging. The specific timing and shot count in the kogation-related processes are managed by, for example, a counter configured to count the ejection shot count. In the present embodiment, the ejection shot count is calculated by a dot-count calculation part 1716 (see FIG. 17) to be described later. Specifically, for example, the entire print head width is divided into multiple regions, the number of ejected droplets (the number of shot dots) in a window that covers all the nozzle arrays is counted, and the counted number divided by the number of the nozzles in the window is regarded as the ejection shot count in the window. In other words, in the present embodiment, the ejection shot count calculated by the dot-count calculation part 1716 is calculated as the ejection shot count per nozzle in each print element board 428. As a method for calculating the ejection shot count, various known techniques may be used and therefore detailed description thereof is omitted herein.

### <Concentration Adjustment of Ink in Circulation Path>

### =Processes During Printing=

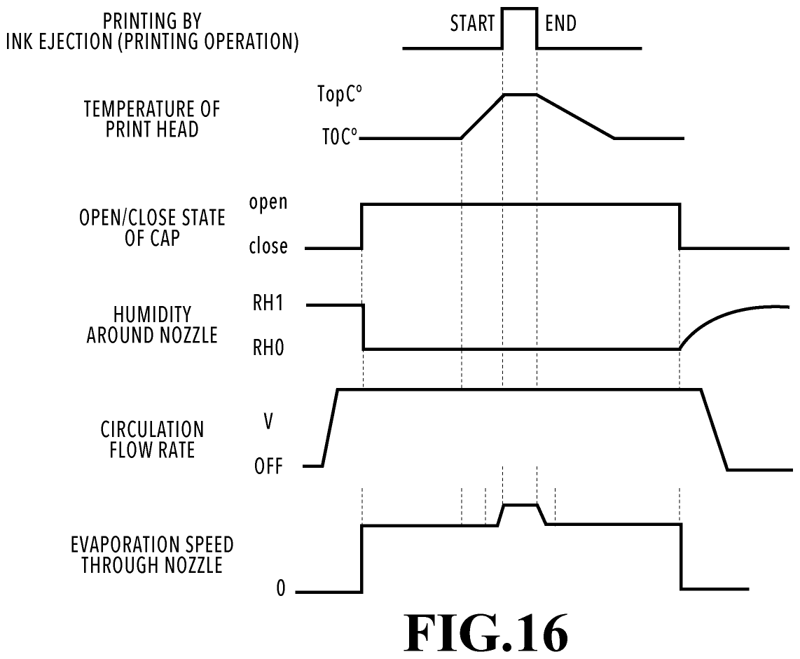

First, processes executed during printing by the printing apparatus 10 will be described. FIG. 16 is a timing chart of multiple processes executed during printing in the printing apparatus 10. In the following description, a state of the printing apparatus 10 before execution of a printing operation based on a job will be referred to as a standby state, as needed. In the standby state of the printing apparatus 10, the pumps 412, 414, and 416 are out of operation and the ink is not circulated in each circulation path 400. The temperature of the print head 26 in the standby state is denoted by T0° C. and the humidity at the nozzles 1002 in the standby state is denoted by RH1.

After the start of a printing operation based on a job in the printing apparatus 10, the engine controller 204 drives the pumps 412, 414, and 416 to circulate the ink in each circulation path 400. Next, the cap member (not illustrated) in the maintenance section 28 is taken off from the nozzle surface in which the nozzles of the print head 26 are formed and the nozzles 1002 are exposed to outside. As a result, the humidity around the nozzles 1002 becomes equal to the humidity (denoted by RH0) in an installation environment of the printing apparatus 10 and the ink is evaporated through the nozzles 1002. After that, temperature adjustment heaters (not illustrated) provided to the print element boards 428 are driven to heat the print element boards 428 to a temperature required for the printing operation. Then, the printing operation for printing a print medium is executed in a state where the flow rate of the ink in the circulation path 400 (circulation flow rate) reaches a predetermined speed V and the temperature of the print element boards 428 reaches a predetermined temperature Top° C.

An evaporation speed of the ink through the nozzles 1002 sharply increases upon taking-off of the cap member. In addition, during the printing operation, the evaporation of the ink proceeds mainly through non-ejection nozzles that are not engaged in ink ejection. The evaporation of the ink through the non-ejection nozzles leads to an increase in the ink concentration in the circulation path 400. Since the circulation flow rate cannot be controlled individually for each nozzle 1002, the evaporation speed of the ink per non-ejection nozzle during the printing operation is constant. Although a component evaporated through the non-ejection nozzles dominates the evaporation of the ink through the nozzles during the printing operation, an ink evaporation amount in the present embodiment is calculated on the assumption that the evaporation proceeds uniformly through all the nozzles regardless of the ejection state in order to simplify the calculation.

After completion of the printing operation, the pumps 412, 414, and 416 are stopped and the circulation of the ink in the circulation path 400 is stopped. After the pumps 412, 414, and 416 are stopped, the circulation flows in the nozzles 1002 are completely stopped when a predetermined time period passes. Thus, the stopping of the pumps 412, 414, and 416 leads to a sharp decrease in the evaporation speed through the non-ejection nozzles. After that, the cap member is brought into contact with the nozzle surface of the print head 26. As a result, the humidity around the nozzles 1002 is increased and recovered to the humidity RH1 before the execution of the printing operation based on the job and the evaporation speed through the non-ejection nozzles is reduced to 0.

### =Adjustment Method=

As described above, in the printing apparatus 10 during the printing operation, evaporation of the liquid component in the ink is promoted and an ink concentration in the circulation path 400 increases. To address this, in the printing apparatus 10, an ink concentration (for example, a pigment concentration) in the circulation path increased due to a printing operation or the like is adjusted to a concentration at which the printing quality will not decrease.

In order to adjust the ink concentration in the circulation path, first, obtaining processing is executed for obtaining a concentration estimate value of the ink in the circulation path 400 thickened due to a printing operation or the like. After that, the ink concentration in the circulation path 400 is adjusted based on the ink concentration estimate value by discharging part of the thickened ink from the circulation path 400 and supplying the fresh ink from the main tank 402 to the circulation path 400. Hereinafter, the processing of adjusting the ink concentration in the circulation path 400 will be referred to as “concentration adjustment” as needed. Through this concentration adjustment, the ink concentration in the circulation path 400 is adjusted within a predetermined concentration range in which the printing quality is unlikely to decrease. In the present embodiment, the discharge of the ink from the circulation path 400 in the concentration adjustment is achieved by driving the print elements 1118 and thereby ejecting the ink through the nozzles 1002.

### =Functional Configuration of Engine Controller 204=

The obtaining processing and the concentration adjustment are executed by the engine controller 204. FIG. 17 is a block diagram illustrating a functional configuration of the engine controller 204. Note that constituents in the engine controller 204 illustrated in FIG. 17 are implemented by a known hardware configuration such as a CPU, a ROM, a RAM, and so on provided in the engine controller 204.

The engine controller 204 includes a print head temperature adjustment control part 1702 configured to control temperature adjustment of each print head 26 by using the temperature adjustment heater (not illustrated) provided to each print element board 428 based on a detection result by a temperature detection part 1701 provided to the print element board 428. Moreover, the engine controller 204 includes an evaporation amount obtaining part 1704 configured to obtain an evaporation amount per unit time through the nozzles 1002. In addition, the engine controller 204 includes a dew point temperature calculation part 1706 configured to calculate a dew point temperature around the nozzle surfaces of the print heads 26 based on a detection result by a temperature and humidity sensor 1700 provided in the printing apparatus 10. The temperature and humidity sensor 1700 is configured to be capable of detecting the temperature and the humidity (relative humidity) in a space between the print heads 26 and a print medium.

The engine controller 204 includes an ink discharge control part 1708 configured to control discharge of the ink from the circulation path 400 and supply of the ink to the circulation path 400 along with the discharge. The engine controller 204 also includes a concentration estimate value calculation part 1710 configured to calculate the ink concentration estimate value in the circulation path 400 and an image density correction part 1712 configured to execute image density correction. Further, the engine controller 204 includes a print duty calculation part 1714 configured to calculate a print duty based on a calculation result by the dot-count calculation part 1716 to be described later. Furthermore, the engine controller 204 includes the dot-count calculation part 1716 configured to calculate the number of ink droplets ejected from the nozzles of each print head 26 based on print data.

### =Obtaining Processing=

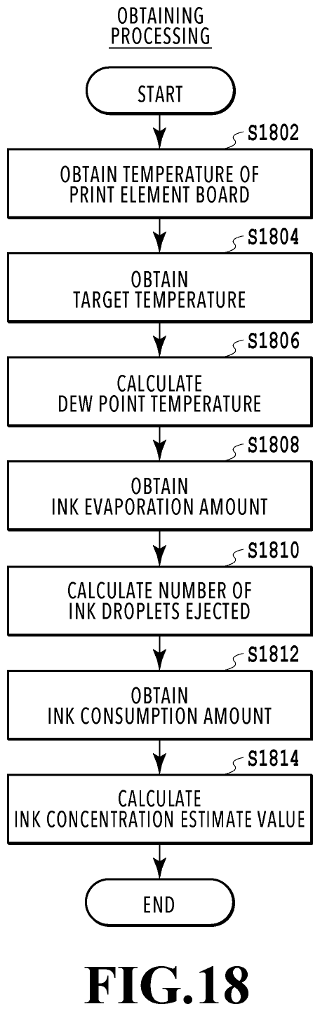

Next, the obtaining processing of obtaining an ink concentration estimate value in the circulation path 400 will be described. FIG. 18 is a flowchart presenting detailed processes in the obtaining processing. The series of processes presented in the flowchart of FIG. 18 is executed by the CPU of the engine controller 204 expanding program code stored in the ROM of the engine controller 204 into the RAM of the engine controller 204 and executing the program code. Instead, some or all of functions in steps in FIG. 18 may be executed by hardware such as an ASIC or electronic circuit.

After the start of the obtaining processing, first in S1802, the print head temperature adjustment control part 1702 obtains the temperature of each of the print element boards 428. Specifically, the print head temperature adjustment control part 1702 obtains a detection result by the temperature detection part 1701 provided to each of the print element boards 428. In S1804, the print head temperature adjustment control part 1702 obtains a target temperature for temperature adjustment control of the print element boards 428 in the print head 26. In the present embodiment, the highest temperature among the temperatures detected by all the temperature detection parts 1701 obtained in S1702 is obtained as the target temperature. The target temperature may be an average value of the detection results of all the temperature detection parts 1701 or the lowest temperature among them.

Next, in S1806, the dew point temperature calculation part 1706 obtains the temperature and the relative humidity detected by the temperature and humidity sensor 1700 and calculates the dew point temperature by using the obtained temperature and relative humidity. Then, in S1808, the evaporation amount obtaining part 1704 obtains an ink evaporation amount per unit time through the nozzles based on the dew point temperature obtained in S1806 and the target temperature obtained in S1804. A storage region such as the ROM or RAM in the engine controller 204 stores a table indicating an ink evaporation amount per unit time corresponding to each pair of the temperature and the dew point temperature of the print element board 428. Accordingly, in S1808, the evaporation amount obtaining part 1704 obtains the ink evaporation amount per unit time by using this table.

In S1810, the dot-count calculation part 1716 counts the number of ink droplets ejected from all the nozzles 1002 in the print head 26. Then, in S1812, the print duty calculation part 1714 calculates a print duty per predetermined time and obtains a consumption amount of the ink to be consumed in the printing operation. Here, in the present embodiment, determination processing of determining a mode of maintenance processing including kogation control and concentration adjustment, details of which will be described later, is executed by using the concentration estimate value obtained in this obtaining processing. This determination processing is executed at certain regular intervals. Therefore, if a printing operation is executed between the immediately preceding determination processing and the current determination processing, the number of ink droplets ejected from the print head 26 between a time point of the immediately preceding obtaining processing and a time point of the current obtaining processing is calculated based on the print data in S1810. In S1812, the consumption amount of the ink between the time point of the immediately preceding obtaining processing and the time point of the current obtaining processing is obtained. Here, if a printing operation is not executed between the immediately preceding determination processing and the current determination processing, the ink is not ejected. Therefore, the processes in S1810 and S1812 are performed by regarding these values as “0”.

After that, in S1814, the concentration estimate value calculation part 1710 calculates the ink concentration estimate value in the circulation path 400 based on the evaporation amount obtained in S1808 and the consumption amount obtained in S1812 and then terminates this obtaining processing. The technique for obtaining an ink concentration estimate value in the circulation path based on the ink evaporation amount per unit time and the concentration amount of the ink consumed during the printing operation is a publicly known technique, so detailed description thereof is omitted herein. In order to simplify the calculation, for example, the concentration estimate value is calculated on the assumption that the ink is in a state after the thickened ink in the circulation path according to the evaporation amount and the ink not thickened become uniform at a certain period of time after mixing. In this case, it actually takes some time for the thickened ink due to evaporation through the nozzles to be mixed uniformly in the circulation path, so the estimate value is calculated deliberately under strict conditions concerning evaporation.

### <Determination Processing>

In the foregoing configuration, the printing apparatus 10 determines, at the predetermined time intervals, whether or not to execute the maintenance processing including kogation control and concentration adjustment, and if determining to execute the maintenance processing, performs the determination processing of determining a mode of the maintenance processing to be executed. This determination processing is executed for each of the print heads 26. In the present embodiment, the kogation control is a process including kogation removal and aging. The time interval for executing the determination processing varies depending on the characteristics of the inks used, the structure of the circulation path 400, the structure of the print element boards 428, and so on. In the present embodiment, in a power-on state, the printing apparatus 10 executes the determination processing at predetermined time intervals. The maintenance processing in the mode determined in the determination processing is executed at a predetermined timing. The predetermined time intervals may be changed as appropriate such for example as intervals of one minute, intervals per unit 2 or more minutes, intervals per unit 30 minutes, or the like.

In the present embodiment, as the mode of the maintenance processing including kogation control and concentration adjustment, four modes of mode A, mode B, mode C, and mode D are executable. Specifically, the mode A is a mode of executing kogation control and concentration adjustment consecutively. The mode B is a mode of executing only concentration adjustment. The mode C is a mode of ejecting the ink in a partial area (for example, preliminary ejection of ejecting the ink not contributing to printing). Then, the mode D is a pressure suction mode of ejecting the ink from each nozzle with application of pressure (without driving the print element) while sucking the ink by applying negative pressure from the outside to each nozzle. In the determination processing, one mode is selected from five modes including the foregoing four modes and a mode “NO”, which is a mode of skipping the maintenance processing. The printing apparatus 10 executes the maintenance processing based on the mode determined in the determination processing. In the case where the mode is determined during a printing operation, the maintenance processing based on the determined mode is executed, for example, at a predetermined timing such as a timing of completion of the printing operation based on the job or a timing of completion of the printing operation on a print medium currently being printed.

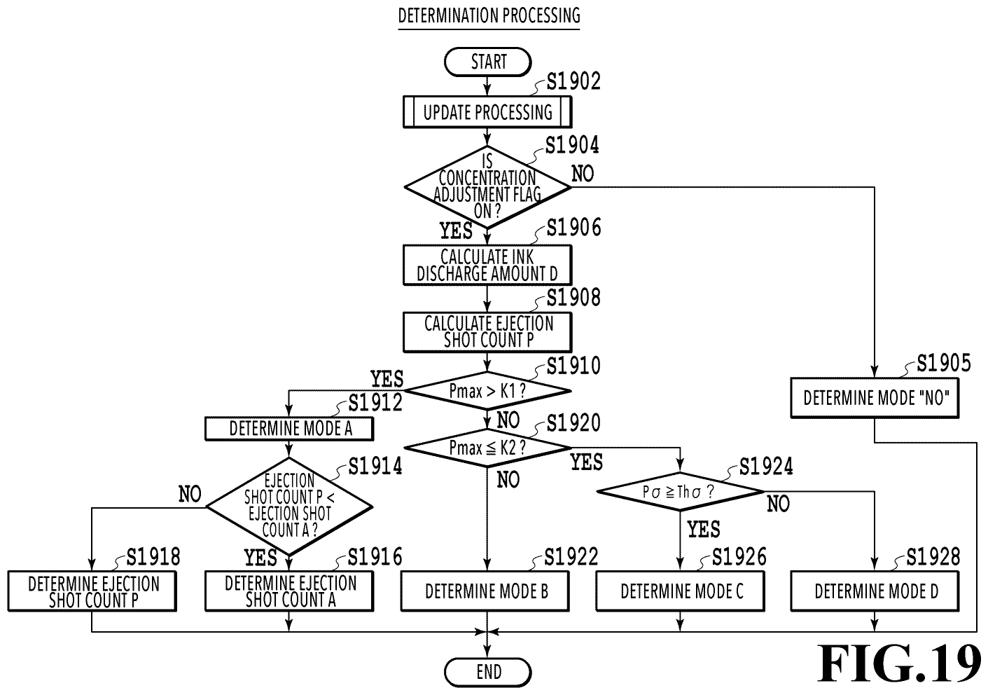

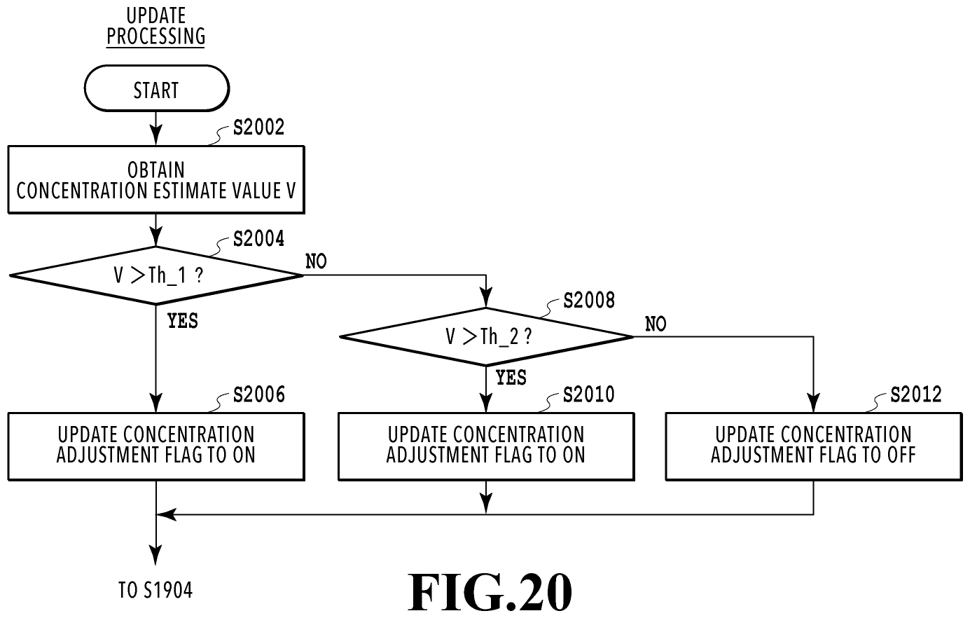

FIG. 19 is a flowchart presenting detailed processes in the determination processing. FIG. 20 is a flowchart presenting detailed processes in update processing, which is a subroutine of the determination processing. The series of processes presented in the flowcharts of FIGS. 19 and 20 is executed by the CPU of the engine controller 204 expanding program code stored in the ROM of the engine controller 204 into the RAM of the engine controller 204 and executing the program code. Instead, some or all of functions in steps in FIGS. 19 and 20 may be executed by hardware such as an ASIC or electronic circuit.

After the start of the determination processing, first in S1902, the CPU of the engine controller 204 (hereinafter simply referred to as “the CPU”) executes the update processing of updating a concentration adjustment flag.

After the start of the update processing, first in S2002, the CPU obtains an ink concentration estimate value V in the circulation path 400. In S2002, the ink concentration estimate value V in the circulation path 400 at a time point when this update processing is being executed is obtained in the above-described obtaining processing. Next, in S2004, the CPU determines whether or not the concentration estimate value V obtained in S2004 exceeds a threshold Th_1. The threshold Th_1 is a value smaller than a concentration value that requires concentration adjustment, and is set to, for example, a value smaller by a certain value than the lower limit value of the ink concentration at which printing quality will decrease.

If it is determined in S2004 that the concentration estimate value V exceeds the threshold Th_1, the CPU updates the concentration adjustment flag to ON in S2006 and the processing proceeds to S1904 to be described later. On the other hand, if it is determined in S2004 that the concentration estimate value V does not exceed the threshold Th_1, the processing proceeds to S2008 and the CPU determines whether or not the concentration estimate value V exceeds a threshold Th_2. The threshold Th_2 is a value smaller by a predetermined value than the threshold Th_1.

If it is determined in S2008 that the concentration estimate value V exceeds the threshold Th_2, the CPU updates the concentration adjustment flag to ON in S2010 and the processing proceeds to S1904 to be described later. On the other hand, if it is determined in S2008 that the concentration estimate value V does not exceed the threshold Th_2, the CPU updates the concentration adjustment flag to OFF in S2012 and the processing proceeds to S1904 to be described later.

In the present embodiment, the concentration adjustment flag is set to ON simply if the concentration estimate value V is determined as exceeding the threshold Th_1 or the threshold Th_2. However, an embodiment is not limited to this. For example, if the concentration estimate value V exceeds the threshold Th_2, a notification that a timing for concentration adjustment will arrive soon may be made to a user and the concentration adjustment flag may be updated to OFF. Instead, if the concentration estimate value V exceeds the threshold Th_2, a warning screen may be displayed and enable a user to select one of “execution of concentration adjustment” and “non-execution of concentration adjustment”. In this case, the concentration adjustment flag is updated to ON if “execution of concentration adjustment” is selected or the concentration adjustment flag is updated to OFF if “non-execution of concentration adjustment” is selected. In this case, if the concentration estimate value V exceeds the threshold Th_1, the concentration adjustment flag is forcibly updated to ON. Here, if the timing for performing concentration adjustment differs, the ink concentration rate also changes. For this reason, if the target ink concentration is set in advance, the amount of ink discharged during concentration adjustment must also be changed in each adjustment. In the present embodiment, the concentration adjustment flag is set to ON simply if the concentration estimate value V is determined as exceeding the threshold Th_1 or the threshold Th_2. Therefore, in the update processing, the concentration adjustment flag may be updated to ON or OFF only by determining whether the concentration estimate value V exceeds the threshold Th_2 while skipping S2004 and S2006.

The description returns to FIG. 19. After the update of the concentration adjustment flag is completed, the processing proceeds to S1904 and the CPU determines whether or not the concentration adjustment flag is ON. If it is determined in S1904 that the concentration adjustment flag is not ON, in other words, the concentration adjustment flag is OFF, the processing proceeds to S1905 and the CPU determines “NO” as the mode of the maintenance processing to be executed and terminates the determination processing. If “NO” is determined as the mode of the maintenance processing to be executed in the determination processing, the maintenance processing is not executed after the determination processing.

On the other hand, if it is determined in S1904 that the concentration adjustment flag is ON, the CPU calculates an ink discharge amount D in S1906. In S1906, the ink discharge amount D, which is the amount of the ink to be discharged from the circulation path 400 in the concentration adjustment, is calculated. The ink discharge amount D is calculated based on the concentration estimate value V obtained in S2002 and the amount of the ink circulating in the circulation path 400. Here, the ink discharge amount D is calculated such that the ink concentration in the circulation path 400 may fall within a predetermined concentration range as a result of discharging the ink discharge amount D of the ink from the circulation path 400 and then supplying an amount of the unevaporated fresh ink corresponding to the ink discharge amount D from the main tank 402. Instead, it is also possible to use the constant ink discharge amount D without determining the ink concentration after the concentration adjustment.

Next, in S1908, the CPU calculates an ejection shot count (dot count) P per nozzle in each print element board 428 in the case where the calculated ink discharge amount D is ejected from the nozzles in the print head 26. After that, the processing proceeds to S1910 and the CPU determines whether or not the greatest ejection shot count Pmax among the calculated ejection shot counts P exceeds a threshold K1. The threshold K1 is a threshold for determining whether or not to execute the process of removing kogation adhering to the upper protective layer 1310. The threshold K1 is determined experimentally depending on the type of the ink used, the structure of the print element board 428, and the like. In the present embodiment, the timing for removing kogation is set to arrive every time approximately 5×10⁸ shots of the ink are ejected from each nozzle as described above. For this reason, in the present embodiment, the threshold K1 is, for example, 5×10⁸ or a value smaller by a certain value than this value.

If it is determined in S1910 that Pmax exceeds the threshold K1, the processing proceeds to S1912 and the CPU determines the mode A and thereafter determines whether the ejection shot count P based on the ink discharge amount D is less than an ejection shot count A for aging in S1914. In the present embodiment, the dot-count calculation part 1716 calculates the ejection shot count per nozzle in each print element board 428. For this reason, the ejection shot count P based on the ink discharge amount D is an ejection shot count per nozzle in the case where the ink discharge amount D of the ink is ejected from all the nozzles in all the print element boards 428. In addition, in the present embodiment, the ejection speed is stabilized by ejecting approximately 5×10⁵ shots of the ink from each nozzle from a state where no kogation adheres. Accordingly, the ejection shot count A for aging is, for example, 5×10⁵ or a value close to this value. These values are just examples and the ejection shot count A is determined experimentally depending on the type of the ink used, the structure of the print element board 428, and the like.

If it is determined in S1914 that the ejection shot count P based on the ink discharge amount D is less than the ejection shot count A, the processing proceeds to S1916. Regarding the ink discharge in the mode A, the CPU determines that the ink will be ejected under driving conditions for aging at the ejection shot count A for aging in S1916, and then terminates this determination processing. On the other hand, if it is determined in S1914 that the ejection shot count P based on the ink discharge amount D is equal to or more than the ejection shot count A, the processing proceeds to S1918. Regarding the ink discharge in the mode A, the CPU determines that the ink will be ejected under driving conditions for concentration adjustment at the ejection shot count P based on the ink discharge amount D in S1918, and then terminates this determination processing. As described above, the driving conditions for aging are set to conditions that more promote kogation adhesion to the surface of the upper protective layer 1310 than the conditions in a normal printing operation such as a concentration adjustment operation.

Here, in the kogation control, after kogation removal, the aging is performed by discharging the ink at the ejection shot count A for aging under the driving conditions for aging. Meanwhile, in the concentration adjustment, after the ink is discharged at the ejection shot count P based on the ink discharge amount D under the normal driving conditions, and then an amount of the ink corresponding to the amount of the ink thus discharged, that is, the amount of the ink based on the ink discharge amount D is supplied from the main tank 402. For this reason, in the mode A of executing the kogation control and the concentration adjustment consecutively, the ink discharges in the two processes for the kogation control and the concentration adjustment are set such that the ink discharge in one of the processes is also used for the ink discharge in the other process. In other words, the mode A is a mode of executing the kogation control and the concentration adjustment consecutively by using the ink discharge in one of the processes for the ink discharge in the other process.

Specifically, in the mode A, after kogation removal, the ink is ejected from each nozzle to discharge the ink from the circulation path 400, and then the amount of the ink corresponding to the amount of the ink thus discharged is supplied from the main tank 402. Therefore, in the mode A via S1916, after kogation removal, the ink is ejected (discharged) under the driving conditions for aging at the ejection shot count A for aging, and then an amount of the ink corresponding to the ejection shot count A is supplied from the main tank 402. Meanwhile, in the mode A via S1918, after kogation removal, the ink is ejected (discharged) under driving conditions for concentration adjustment at the ejection shot count P based on the ink discharge amount D, and then an amount of the ink corresponding to the ejection shot count P is supplied from the main tank 402.

Although the ink discharge in the mode A is determined in S1918 such that the ink will be discharged at the ejection shot count P based on the ink discharge amount D under the driving conditions for concentration adjustment, the ink discharge in the mode A is not limited to this. For example, out of the ejection shot count P based on the ink discharge amount D, the ejection shot count A less than the ejection shot count P may be used for driving under the driving conditions for aging. Then, just an ejection shot count equal to the difference between the ejection shot count P and the ejection shot count A may be determined for driving under the driving conditions for concentration adjustment. This makes it possible to reliably secure the amount of kogation adherence in aging.

On the other hand, if it is determined in S1910 that Pmax does not exceed the threshold K1, the processing proceeds to S1920 and the CPU determines whether or not Pmax is equal to or less than a threshold K2. The threshold K2 is a smaller value than the threshold K1 and is, for example, a half value of the threshold K1. In the present embodiment, since the threshold K1 is 5×10⁸, the threshold K2 is 2.5×10⁸.

If it is determined in S1920 that Pmax is more than the threshold K2, the processing proceeds to S1922 and the CPU determines the mode B and terminates this determination processing. Specifically, in the mode B, the normal concentration adjustment is performed in which the ink is ejected from each nozzle at the ejection shot count P based on the ink discharge amount D to discharge the ink from the circulation path 400, and then the amount of the ink corresponding to the amount of the ink thus discharged is supplied from the main tank 402.

On the other hand, if it is determined in S1920 that Pmax is equal to or less than the threshold K2, the processing proceeds to S1924 and the CPU determines whether a deviation Pσ of the ejection shot count P among the print element boards 428 is equal to or more than a threshold Thσ. In S1924, the standard deviation Pσ of the ejection shot count P for each of the print element boards 428 is obtained and whether or not this standard deviation Pσ is equal to or more than the threshold Thσ is determined. The threshold Thσ is set to a value that enables extraction of a print element board 428 whose ejection shot count is equal to or less than a certain shot count, for example, 1.0×10⁸ shots. In short, it is determined in S1924 whether or not there is a print element board 428 in which Pσ≥Thσ holds.

If it is determined in S1924 that Pσ≥Thσ holds, that is, there is a print element board 428 in which Pσ≥Thσ holds, the processing proceeds to S1926 and the CPU determines the mode C and terminates this determination processing. Specifically, in the mode C, preliminary ejection at a predetermined shot count is performed from the nozzles in the print element board 428 having a small ejection shot count satisfying Pσ≥Thσ. If it is determined in S1924 that Pσ≥Thσ does not hold, that is, there is no print element board 428 in which Pσ≥Thσ holds, the processing proceeds to S1928, and the CPU determines the mode D and terminates this determination processing. Specifically, in the mode D, pressure suction is performed in all the print element boards 428 by ejecting the ink from the nozzles with application of pressure (without driving the print elements) while sucking the ink from the nozzles. Thus, in the present embodiment, the engine controller 204 functions as a control part configured to determine whether or not to execute the maintenance processing including the kogation control and the concentration adjustment, and to perform control to determine the mode of the maintenance processing to be executed.

### <Effects>

As described above, in the mode A of executing the kogation control and the concentration adjustment, the printing apparatus 10 uses the ink discharge in one of the processes for the kogation control and the concentration adjustment for the ink discharge in the other process. As compared with a case where the kogation control and the concentration adjustment are separately executed, this can shorten a time required for the kogation control and the concentration adjustment and accordingly reduce a decrease in the productivity of the printing apparatus 10. In addition, since the amount of the waste ink generated is reduced, an increase in the production cost can be suppressed.

Further, the printing apparatus 10 is capable of executing the maintenance processing in one of the different modes depending on the ejection shot count based on the concentration estimate value. This makes it possible to execute the maintenance processing in each mode of ejection operation depending on the concentration estimate value, thereby suppressing the adhesion of unnecessary kogation to the upper protective layer 1310 and contributing to a longer lifespan of the print head 26.

### Second Embodiment

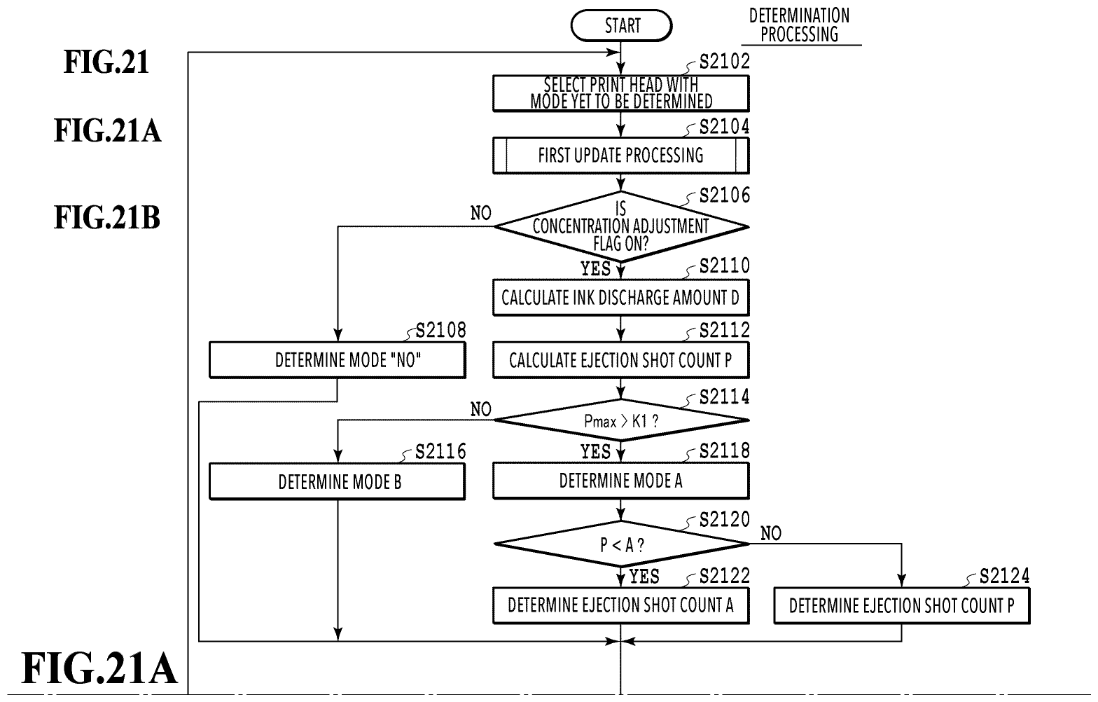

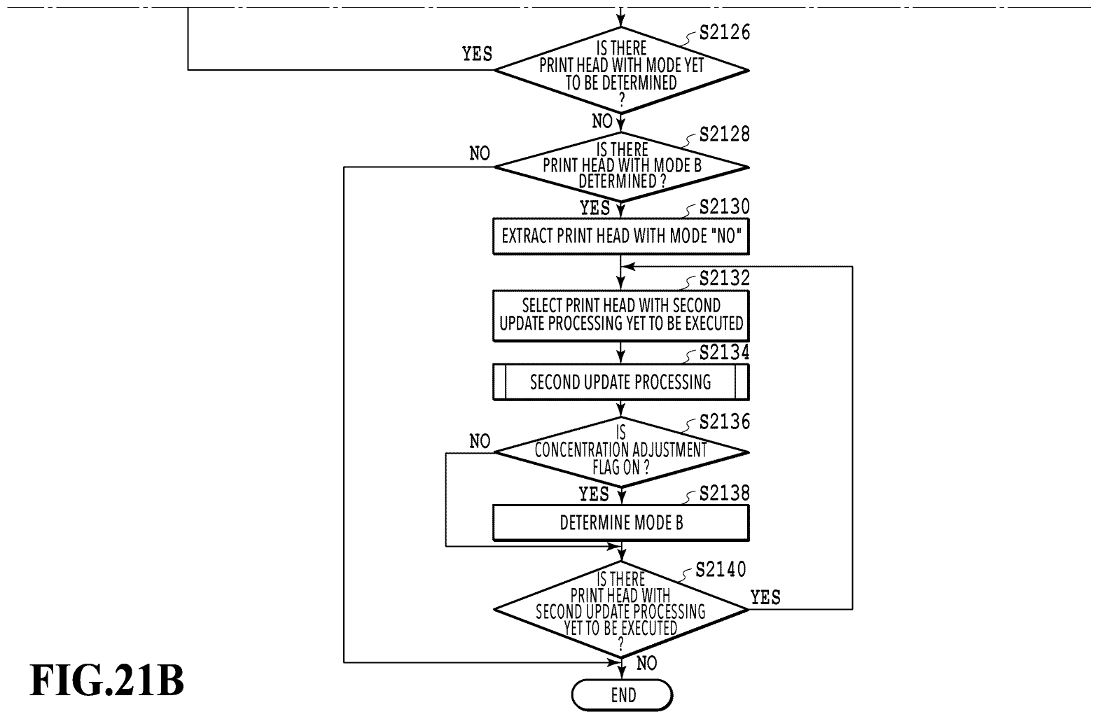

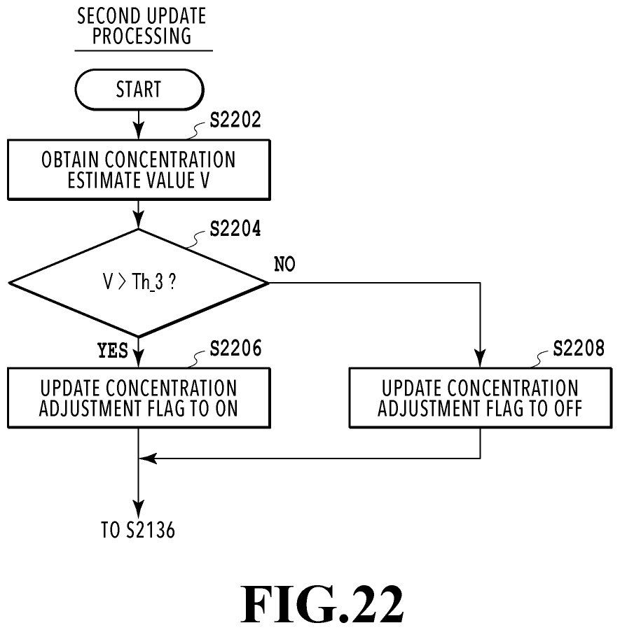

Next, in reference to FIGS. 21 and 22, a printing apparatus according to a second embodiment will be described. In the following description, the constituents same as or corresponding to those in the first embodiment described above will be given the same reference signs as in the first embodiment and detailed explanations thereof will be omitted.

In the second embodiment, the following points are different from those in the first embodiment. First, the mode A or the mode B is selected in the case where the maintenance processing is executed based on the concentration estimate value. In addition, in the case where there is a print head 26 for which the mode B is determined, the update processing using a smaller threshold is performed on a print head 26 for which the mode “NO” is determined and whether or not the mode B can be set for the print head 26 is determined based on that update result. Hereinafter, the determination processing executed in the printing apparatus 10 according to the second embodiment will be described in detail.

### <Determination Processing>

FIGS. 21A and 21B are flowcharts presenting detailed processes in the determination processing executed in the printing apparatus 10 according to the second embodiment. FIG. 22 is a flowchart presenting detailed processes in second update processing, which is a subroutine of the determination processing. The series of processes presented in the flowcharts of FIGS. 21 and 22 is executed by the CPU of the engine controller 204 expanding program code stored in the ROM of the engine controller 204 into the RAM of the engine controller 204 and executing the program code. Instead, some or all of functions in steps in FIGS. 21 and 22 may be executed by hardware such as an ASIC or electronic circuit.

After the start of the determination processing, first in S2102, the CPU selects a print head 26 for which the mode is yet to be determined. Specifically, in S2102, the CPU selects any one of the print heads 26 for which the mode of the maintenance processing is yet to be determined among the print heads 26 provided in the printing apparatus 10. In S2104, the CPU performs first update processing for the selected print head 26. The specific detailed processes in the first update processing are the same as those in the update processing in the first embodiment, and description thereof is omitted herein. Here, in the determination processing in the second embodiment, there are two modes of the maintenance processing to be determined: the mode A and the mode B (strictly speaking, there are three modes including the mode “NO”). For this reason, the threshold Th_1 used in the first update processing is set to, for example, a lower limit value of the ink concentration at which the print quality will decrease or a value smaller by a certain value than the lower limit value.

Next, in S2106, the CPU determines whether or not the concentration adjustment flag is ON. If it is determined in S2106 that the concentration adjustment flag is OFF, the processing proceeds to S2108 in which the CPU determines the mode “NO”, and proceeds to S2126 to be described later. On the other hand, if it is determined in S2106 that the concentration adjustment flag is ON, the CPU calculates the ink discharge amount D in S2110 and calculates the ejection shot count Pin S2112. The specific detailed processes in S2110 and S2112 are the same as the above processes in S1906 and S1908.

After that, in S2114, the CPU determines whether or not the greatest ejection shot count Pmax among the calculated ejection shot counts P exceeds the threshold K1. The specific detailed process in S2114 is the same as the above process in S1910. If it is determined in S2114 that Pmax does not exceed the threshold K1, the processing proceeds to S2116 in which the CPU determines the mode B, and proceeds to S2126 to be described later. The specific detailed process in S2116 is the same as the above process in S1922.

On the other hand, if it is determined in S2114 that Pmax exceeds the threshold K1, the processing proceeds to S2118, and the CPU determines the mode A and then determines whether or not the ejection shot count P based on the ink discharge amount D is less than the ejection shot count A in S2120. If it is determined in S2120 that the ejection shot count P based on the ink discharge amount D is less than the ejection shot count A, the processing proceeds to S2122. Regarding the ink discharge in the mode A, the CPU determines that the ink will be ejected under the driving conditions for aging at the ejection shot count A for aging in S2122, and then the processing proceeds to S2126 to be described later. On the other hand, if it is determined in S2120 that the ejection shot count P based on the ink discharge amount D is equal to or more than the ejection shot count A, the processing proceeds to S2124. Regarding the ink discharge in the mode A, the CPU determines that the ink will be ejected under the driving conditions for concentration adjustment at the ejection shot count P based on the ink discharge amount D, and then the processing proceeds to S2126 to be described later. The specific detailed processes in S2120 to S2124 are the same as the above processes in S1914 to S1918.

In S2126, the CPU determines whether or not there is a print head 26 for which the more is yet to be determined. Specifically, in S2126, the CPU determines whether or not there is a print head 26 for which the mode of the maintenance processing is yet to be determined among the print heads 26 provided in the printing apparatus 10. If it is determined in S2126 that there is a print head 26 for which the mode is yet to be determined, the processing returns to S2102. On the other hand, if it is determined in S2126 that there is no print head 26 for which the mode is yet to be determined, the processing proceeds to S2128 and the CPU determines whether there is a print head 26 for which the mode B is determined.

If it is determined in S2128 that there is no print head 26 for which the mode B is determined, this determination processing ends. On the other hand, if it is determined in S2128 that there is a print head 26 for which the mode B is determined, the processing proceeds to S2130 and the CPU extracts the print heads 26 for which the mode “NO” is determined. If none of the print heads 26 for which the mode “NO” is determined exists and is extracted in S2130, this determination processing ends.

Next, in S2132, the CPU selects a print head 26 on which the second update processing (to be described later) is yet to be executed among the extracted print heads 26. Then, in S2134, the CPU executes the second update processing on the print head 26 selected in S2132.

After the start of the second update processing, first in S2202, the CPU obtains the ink concentration estimate value V in the circulation path 400. The specific detailed process in S2202 is the same as in S2002 described above. Next, in S2204, the CPU determines whether or not the concentration estimate value V obtained in S2202 exceeds a threshold Th_3. The threshold Th_3 is, for example, a value obtained by multiplying the threshold Th_1 by 0.8. Here, the threshold Th_3 is not limited to the value obtained by multiplying the threshold Th_1 by 0.8. The threshold Th_3 may be any value smaller than and close to the threshold Th_1 and is set to a value at a predetermined percentage of the threshold Th_1. The threshold Th_3 in the above process may be set as appropriate as long as the print head 26 having the concentration estimate value for which execution of the concentration adjustment is considered as reasonable also from the viewpoints of cost and so on can be extracted in S2136 to be described later.

If it is determined in S2204 that the concentration estimate value V exceeds the threshold Th_3, the CPU updates the concentration adjustment flag to ON in S2206 and the processing proceeds to S2136 to be described later. On the other hand, if it is determined in S2204 that the concentration estimate value V does not exceed the threshold Th_3, the CPU updates the concentration adjustment flag to OFF in S2208 and the processing proceeds to S2136 to be described later.

The description returns to FIG. 21B. After the second update processing is completed, the CPU determines whether or not the concentration adjustment flag is ON in S2136. The specific detailed process in S2136 is the same as in S2106 described above. If it is determined in S2136 that the concentration adjustment flag is OFF, the processing proceeds to S2140 to be described later. In other words, the processing proceeds without changing the mode. On the other hand, if it is determined in S2136 that the concentration adjustment flag is ON, the processing proceeds to S2138, and the CPU determines the mode B for the print head 26 most recently selected in S2132. In other words, through this process, the mode of the print head 26 most recently selected in S2132 is changed from “NO” to “B”.

After that, in S2140, the CPU determines whether or not there is a print head 26 on which the second update processing is yet to be executed among the print heads 26 extracted in S2130. If it is determined in S2140 that there is a print head 26 on which the second update processing is yet to be executed, the processing returns to S2132. On the other hand, if it is determined in S2140 that there is no print head 26 on which the second update processing is yet to be executed, this determination processing ends.

### <Effects>

As described above, in the mode A of executing the kogation control and the concentration adjustment, the printing apparatus 10 uses the ink discharge in one of the processes for the kogation control and the concentration adjustment for the ink discharge in the other process. As compared with the case where the kogation control and the concentration adjustment are separately executed, this can shorten a time required for the kogation control and the concentration adjustment and accordingly reduce a decrease in the productivity of the printing apparatus 10. In addition, since the amount of the waste ink generated is reduced, an increase in the production cost can be suppressed.

In addition, in the case where there is a print head 26 for which the mode B of executing only the concentration adjustment is determined, the mode B is determined for a print head 26 for which execution of the concentration adjustment is considered as reasonable among the print heads 26 for which the mode “NO” is determined. This reduces the number of executions of the mode B of executing only the concentration adjustment and thereby improves the productivity.

### Other Embodiments

The foregoing embodiments may be modified as will be described below in (1) to (6).

(1) In the above second embodiment, in the determination processing, the mode of the maintenance processing is determined from the mode A, the mode B, and the mode “NO” in the processes before S2126, but the determination processing is not limited to this. As in the first embodiment, the mode of the maintenance processing may be determined from the mode A, the mode B, the mode C, the mode D, and the mode “NO”. In this case, as the processes in S2126 and the subsequent steps, the same processes as in the foregoing second embodiment are executed.

(2) In the foregoing embodiments, the printing apparatus 10 is a so-called full-line type of printing apparatus using a long print head entirely extending in the width direction of a print area on a print medium, but is not limited to this. Instead, a so-called serial scan type of printing apparatus using a print head configured to eject the inks while moving in directions crossing the print medium conveyance direction may be used.

(3) In the foregoing embodiments, the determination processing uses the concentration estimate value obtained by estimating the concentration of the ink circulating in the circulation path 400, but is not limited to this. The printing apparatus may include a constituent capable of measuring the ink concentration in the circulation path 400 and determine the mode of the maintenance processing in a determination unit using the concentration value measured by that constituent.

(4) In the foregoing embodiments, the control section 200 (the engine controller 204) in the printing apparatus 10 executes the determination processing of determining the mode of the maintenance processing including the kogation control and the concentration adjustment, but an embodiment is not limited to this. An external apparatus connected to the printing apparatus 10, for example, the upper-level apparatus HC2, the host apparatus HC1, or the like may execute the determination processing based on information output from the printing apparatus 10.

(5) Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

(6) The foregoing embodiments and the foregoing various modifications in (1) to (5) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168502, filed Sep. 28, 2023, which is hereby incorporated by reference wherein in its entirety.

What is claimed is:

1. A printing apparatus comprising:
a print unit configured to perform printing by ejecting an ink from a nozzle by using thermal energy generated by a heating element;
a circulation path configured to circulate the ink so as to supply the print unit with the ink and resupply the print unit with the ink which flows out from the print unit; and
a control unit configured to be capable of performing a first control of causing kogation to adhere to a protective layer covering the heating element by ejecting and discharging the ink through the nozzle, and a second control of making concentration adjustment of the ink in the circulation path by ejecting and discharging the ink from the nozzle to discharge the ink from the circulation path and supplying the circulation path with an amount of the ink corresponding to the amount of the ink thus discharged, wherein in a case where the first control and the second control are consecutively executed, the control unit uses the ink discharge in one of the controls for the ink discharge in the other control.

2. The printing apparatus according to claim 1, wherein
in the first control, after kogation generated in a printing operation is removed, the kogation is caused to adhere to the protective layer.

3. The printing apparatus according to claim 1, wherein
in the second control, a discharge amount of the ink to be discharged from the circulation path is calculated based on a concentration of the ink in the circulation path.

4. The printing apparatus according to claim 3, wherein
the concentration is an estimate value.

5. The printing apparatus according to claim 3, wherein
the control unit determines which of a first mode of executing the first control and the second control consecutively and a second mode of executing the second control is to be executed, based on an ejection shot count of the ink from the nozzle depending on the discharge amount.

6. The printing apparatus according to claim 5, wherein
the control unit determines, as an ejection shot count of the ink to be ejected from the nozzle in consecutive execution of the first control and the second control, a first ejection shot count for kogation adhesion in the first control or a second ejection shot count based on the discharge amount.

7. The printing apparatus according to claim 6, wherein
in the first control, the heating element is driven under a second driving condition that promotes generation of kogation more than a first driving condition for a printing operation,
the control unit drives the heating element under the second driving condition in the case where the first ejection shot count is determined as the ejection shot count of the ink to be ejected from the nozzle in consecutive execution of the first control and the second control, and
the control unit drives the heating element under the first driving condition in the case where the second ejection shot count is determined as the ejection shot count of the ink to be ejected from the nozzle in consecutive execution of the first control and the second control.

8. The printing apparatus according to claim 6, wherein
in the first control, the heating element is driven under a second driving condition that promotes generation of kogation more than a first driving condition for a printing operation,
in the case where the first ejection shot count is determined as the ejection shot count of the ink to be ejected from the nozzle in consecutive execution of the first control and the second control, the control unit drives the heating element under the second driving condition, and
in the case where the second ejection shot count that is more than the first ejection shot count is determined as the ejection shot count of the ink to be ejected from the nozzle in consecutive execution of the first control and the second control, the control unit drives the heating element under the second driving condition just at the first ejection shot count and drives the heating element under the first driving condition just at a difference between the first ejection shot count and the second ejection shot count.

9. The printing apparatus according to claim 3, wherein
in the print unit, a plurality of boards each including the heating element are arrayed,
the control unit is further capable of executing a third control on each of the boards for executing preliminary ejection that is ejection of the ink not contributing to printing, and a fourth control of executing pressure suction including ejecting the ink from the nozzle while sucking the ink by applying negative pressure from outside to the nozzle,
based on the greatest ejection shot count among the ejection shot counts of the ink from the nozzles of the respective boards based on the discharge amount, the control unit determines to execute any one of modes including a first mode of executing the first control and the second control consecutively, a second mode of executing the second control, a third mode of executing the third control, and a fourth mode of executing the fourth control.

10. The printing apparatus according to claim 9, wherein
the control unit determines to execute the first mode based on the greatest ejection shot count and a first threshold, and determines to execute the second mode based on the greatest ejection shot count and a second threshold that is a value smaller than the first threshold.

11. The printing apparatus according to claim 10, wherein
the second threshold is a half value of the first threshold.

12. The printing apparatus according to claim 9, wherein
the control unit executes any one of the third mode and the fourth mode based on a deviation in the ejection shot count of the ink from the nozzle in each of the boards.

13. The printing apparatus according to claim 1, wherein
the control unit determines whether or not to execute maintenance processing including the first control and the second control based on a concentration of the ink in the circulation path.

14. The printing apparatus according to claim 13, wherein
in the case where the maintenance processing is executed, the control unit determines to forcibly execute the maintenance processing if the concentration of the ink in the circulation path exceeds a first value or allows execution of the maintenance processing to be selected if the concentration is equal to or less than the first value and exceeds a second value that is smaller than the first value.

15. The printing apparatus according to claim 1, wherein
a plurality of the print units are provided,
the control unit is capable of determining whether or not to execute maintenance processing including the first control and the second control on each of the print units based on a concentration of the ink in the circulation path and a first threshold, and if determining to execute the maintenance processing, determining, as a mode of the maintenance processing, any one of a first mode of executing the first control and the second control consecutively and a second mode of executing the second control, and
in a case where there is the print unit for which the second mode is determined, the control unit determines the second mode for the print unit for which the maintenance processing is determined not to be executed, based on the concentration of the ink in the circulation path and a second threshold that is at a predetermined percentage of the first threshold.

16. A method of controlling a printing apparatus including a print unit configured to perform printing by ejecting an ink from a nozzle by using thermal energy generated by a heating element, and a circulation path configured to circulate the ink so as to supply the print unit with the ink and resupply the print unit with the ink which flows out from the print unit, the method comprising:
in a case where a first control of causing kogation to adhere to a protective layer covering the heating element by ejecting and discharging the ink through the nozzle, and a second control of making concentration adjustment of the ink in the circulation path by ejecting and discharging the ink from the nozzle to discharge the ink from the circulation path, and supplying the circulation path with an amount of the ink corresponding to the amount of the ink thus discharged are consecutively executed, using the ink discharge in one of the controls for the ink discharge in the other control.

17. A non-transitory computer readable storage medium storing a program for causing a computer to perform a control method, the control method being a method of controlling a printing apparatus including a print unit configured to perform printing by ejecting an ink from a nozzle by using thermal energy generated by a heating element, and a circulation path configured to circulate the ink so as to supply the print unit with the ink and resupply the print unit with the ink which flows out from the print unit, the control method comprising:
in a case where first control of causing kogation to adhere to a protective layer covering the heating element by ejecting and discharging the ink through the nozzle, and second control of making concentration adjustment of the ink in the circulation path by ejecting and discharging the ink from the nozzle to discharge the ink from the circulation path, and supplying the circulation path with an amount of the ink corresponding to the amount of the ink thus discharged are consecutively executed, using the ink discharge in one of the controls for the ink discharge in the other control.
